(19) United States
(12) Patent Application Publication
(10) Pub. No.: US 2008/0259248 A1
(43) Pub. Date: Oct. 23, 2008

(54) Multilens member, illumination apparatus, and liquid crystal display apparatus

(75) Inventors: Katsusuke Shimazaki, Ibaraki-shi (JP); Youichi Ogawa, Ibaraki-shi (JP); Masataka Sato, Ibaraki-shi (JP); Eiji Koyama, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD, IBARAKI-SHI (JP)

(21) Appl. No.: 12/081,673

(22) Filed: Apr. 18, 2008

(30) Foreign Application Priority Data
Apr. 19, 2007 (JP) 2007-110818
Mar. 31, 2008 (JP) 2008-89480

(51) Int. Cl. G02F 1/1335; F21V 7/04

(52) U.S. Cl. 349/65; 362/615

(57) ABSTRACT

A multilens member is provided, the multilens member including a base member which has light transmissivity; a plurality of first lenses which are formed on the base member; and a plurality of second lenses which are formed on the plurality of first lenses and which are joined to the plurality of first lenses on first surfaces opposed to the base member; wherein the first surfaces of the second lenses have junction which are joined to the first lenses and overhang which overhangs outwardly from the junction portions. That is, the multilens member having the overhang shape is provided. Accordingly, it is possible to provide the optical member which improves the optical performance of an illumination apparatus and which realizes the thin size and the low cost of the illumination apparatus and a liquid crystal display apparatus.

### CROSS REFERENCE TO RELATED APPLICATION

The present application claims priority from Japanese Patent Application Nos. 2007-110818 and 2008-89480, filed on Apr. 19, 2007, and Mar. 31, 2008, respectively, the disclosure of which is incorporated herein by reference in its entirety.

### BACKGROUND OF THE INVENTION

1 Field of the Invention

The present invention relates to a multilens member which controls the directivity of the incident light, the multilens member having an overhang shape. The present invention also relates to an illumination apparatus and a liquid crystal display apparatus based on the use of the same.

2. Description of the Related Art

Conventionally, various types of illumination apparatuses, such as backlight units for liquid crystal displays, are provided with any mechanism for adjusting the brightness and the broadening of the light beam emitted from the light source. In most of the illumination apparatuses, an optical member such as an optical sheet, which controls the directivity of the light, is installed in an optical path thereof or an light-exit port of a light source housing. The optical member has the light transmissivity, and it has such a function that the traveling direction of the incident light is aligned or uniformized in the predetermined direction and/or the incident light is diffused or diverged.

A representative example of the optical member, which is provided to uniformize the traveling direction of the incident light in the predetermined direction, i.e., to control the directivity of the incident light, is a prism sheet (see, for example, Japanese Patent Application Laid-open No. 10-506500 (PCT)). The prism sheet generally has the following structure. That is, a plurality of prism-shaped optical structural members (hereinafter referred to as “prism-shaped structural members” as well) or a lenticular lens-shaped optical structural members (hereinafter referred to as “lens-shaped structural members” as well) are continuously aligned or arranged on a sheet-shaped base member. The prism-shaped structural members extend in a predetermined direction and each of them has a triangular cross section in a direction perpendicular to the extending direction. The lens-shaped structural members extend in a predetermined direction and each of them has a semicircular (semielliptic) cross section in a direction perpendicular to the extending direction. In the case of the prism sheet, the traveling direction of the light beam (directivity of the light) is controlled in accordance with the prism effect or the lens effect by the optical structural members formed on the base member.

Conventionally, in the backlight unit for the liquid crystal display apparatus, for example, two prism sheets, each of which has a plurality of prism-shaped structural members provided on a base member as described above, are used. The respective prism sheets are arranged so that the extending directions of the prism-shaped structural members thereof are perpendicular to one another (see, for example, Japanese Patent Application Laid-open No. 10-506500 (PCT)). FIG. 21 shows a general arrangement of such a backlight unit for the liquid crystal display apparatus. FIG. 22 shows a general structure of the prism sheet. As shown in FIG. 21, the backlight 201 for the liquid crystal display apparatus mainly includes, for example, a light source 203, an optical guide plate 204 which changes the light 210 emitted from the light source 203 into the surface light source, a reflecting sheet 205 which is arranged under or below the optical guide plate 204 (on the side opposite to a liquid crystal display panel 202), and a large number of functional optical sheet groups 206 to 208 which are arranged over or above the optical guide plate 204 (on the side of the liquid crystal display panel 202). The functional optical sheet groups mainly include, for example, a lower diffusion sheet 206, a prism sheet group 207, and an upper diffusion sheet 208. In FIG. 21, the respective optical members are depicted while being separated from each other, in order to comprehensively understand the arrangement of the liquid crystal display apparatus 200. However, actually, the respective optical members are stacked while making contact with each other.

The prism sheet group 207 is composed of two prism sheets 207a, 207b. As shown in FIG. 22, each of the prism sheets has such a structure that a plurality of prism-shaped structural members 207d, each of which has a triangular cross section and which extend in a predetermined direction, are aligned in parallel on a sheet-shaped base member 207c. In the backlight 201, the respective prism sheets 207a, 207b are arranged so that the extending directions of the prism-shaped structural members 207d of the respective prism sheets 207a, 207b are perpendicular to one another. The reason, why the two prism sheets are used and the respective prism sheets 207a, 207b are arranged so that the extending directions of the prism-shaped structural members 207d of the respective prism sheets 207a, 207b are perpendicular to one another in the backlight unit 201 for the liquid crystal display apparatus as shown in FIG. 21, is as follows.

In the case of the backlight unit 201 based on the side light system as shown in FIG. 21, the light source 203 is arranged on the side of the optical guide plate 204. Therefore, the light 211, which is emitted from the light exit surface 204a of the optical guide plate 204, has the directivity which is non-uniform in the plane of the light exit surface 204a. Therefore, in the case of the liquid crystal display apparatus 200 based on the side light system as shown in FIG. 21, it is necessary that the directivity of the light 211 allowed to pass through the optical guide plate 204 should be uniformized to uniformly radiate the light 212 onto the back surface of the liquid crystal display panel 202. The functional optical sheet groups 206 to 208 have the role to adjust (uniformize) the directivity of the light 211 allowed to pass through the optical guide plate 204. In particular, each of the prism sheets 207a 207b plays such a role that the light 211, which is allowed to income via the optical guide plate 204, is refracted and collected to enhance the luminance by means of the prism-shaped structural members 207d. However, if only one prism sheet as shown in FIG. 22 is used, then the directivity of the light 211 allowed to pass through the optical guide plate 204 can be adjusted in only one direction (direction perpendicular to the extending direction of the prism-shaped structural members), and it is impossible to adjust the directivity in any other direction, for example, in a direction perpendicular to the one direction. In such a situation, it is impossible to sufficiently uniformize the directivity of the light 211, and it is impossible to obtain any sufficient luminance. In view of the above, in the case of the conventional backlight unit 201 as shown in FIG. 21, the two prism sheets 207a, 207b are arranged so that the extending directions of the prism-shaped structural members 207d are perpendicular to one another, in order to sufficiently uniformize the directivity of the light 211, and thus the directions of control of the directivity of the light 211 are increased.

The following methods have been hitherto used as the method for forming the optical structural members such as those having, for example, the prism-shaped form or the lenticular lens-shaped form on the sheet-shaped base member in the optical member such as the prism sheet as described above. The methods include, for example, the thermal transfer (heat transfer) system and the photo-polymer method. In the thermal transfer method, a mold, which has recesses, on a surface thereof, corresponding to the shapes of the optical structural members such as those having, for example, the prism-shaped form or the lenticular lens-shaped form (as obtained by inverting the shapes of the optical structural members), is manufactured; the mold is heated; and the base member is pressed thereagainst to transfer the recesses of the surface of the mold onto the base member. In the photo-polymer method, the space between the mold and the base member is filled with an ultraviolet-curable resin, and then the resin is cured by being irradiated with the ultraviolet light to form the optical structural members.

An optical sheet, in which optical structural members are formed on both surfaces of a sheet-shaped base member, has been hitherto suggested as an optical sheet for controlling the directivity of the light-(see, for example, Japanese Patent No. 3455884).

### SUMMARY OF THE INVENTION

As described above, in the conventional liquid crystal display apparatus and/or the illumination apparatus called “backlight unit” to be installed on the back surface of the display device such as the liquid crystal panel, a plurality of optical sheets ( for example, two prism sheets) are stacked. When the number of sheets is increased, the scattering and the absorption of the transmitted light are increased, and the optical performance is deteriorated. Further, when the number of sheets is increased, problems arise, for example, such that the thicknesses of the illumination apparatus and the liquid crystal display apparatus are increased, and the cost is raised.

The present invention has been made in order to solve the problems as described above, an object of which is to provide an optical member as well as an illumination apparatus and a liquid crystal display apparatus provided with the same, wherein it is possible to improve the optical performance of the illumination apparatus and the liquid crystal display apparatus and it is possible to realize the thin sizes (small sizes) and the low cost of the illumination apparatus and the liquid crystal display apparatus.

According to a first aspect of the present invention, there is provided a multilens member including a base member which has light transmissivity; a plurality of first lenses which are formed on the base member; and a plurality of second lenses each of which has a first surface facing the base member, and each of which is joined onto one of the first lenses at the first surface, wherein: the first surface of each of the second lenses has a junction which is joined to one of the first lenses and an overhang which overhangs outwardly from the junction.

The multilens member of the present invention resides in the optical member to provide the optical function including, for example, the prism function and the lens function with respect to the incident light, wherein the first lens group composed of the plurality of first lenses formed on the base member and the second lens group composed of the plurality of second lenses are joined to one another. That is, the optical member includes the optical structural member which is provided on the base member and which is composed of the first lens group and the second lens group. The phrase “first lenses and second lenses are joined” referred to in this specification has the meaning including not only the case in which the first lenses and the second lenses are directly jointed to one another by means of, for example, the fusion or welding but also the case in which the first lenses and the second lenses are indirectly joined to one another by using, for example, the adhesive (by the aid of any adhesive layer). When the surface of the first lens opposed to the base member is a curved surface, and the base member and the first lens make point-to-point contact with each other, then the surface of the first lens, which is disposed in the tangential direction of the portion allowed to make contact with the base member, is the surface of the first lens opposed to the base member.

In the multilens member of the present invention, for example, when both of the first lenses and the second lenses are formed with the prism-shaped structural members (structural members which extend in the predetermined direction and each of which has the triangular cross section in the direction perpendicular to the extending direction) as described above, and when the first lens group and the second lens group are joined to one another so that the extending directions of the prism-shaped structural members of the first lenses and the second lenses are perpendicular to one another, then the function, which is the same as or equivalent to that of the conventional prism sheet group composed of two prism sheets as described above, is obtained with one optical member. In this arrangement, in the case of the multilens member of the present invention, it is possible to reduce the thickness by an amount corresponding to one sheet of the base member of the prism sheet as compared with the conventional prism sheet group. Therefore, it is possible to realize the thin size and the low cost of the optical member. In the case of the multilens member of the present invention, it is possible to reduce the thickness by the amount corresponding to one sheet of the base member of the prism sheet as compared with the conventional prism sheet group. Therefore, it is possible to reduce the scattering and the absorption of the transmitted light, and it is possible to improve the optical performance.

In the case of the multilens member of the present invention, when the first lenses and the second lenses, which have different functions with respect to the incident light, are used, it is possible to allow one optical member to possess a plurality of optical functions. Therefore, it is also possible to widen the degree of freedom of the design of the optical member. It is possible to provide the optical member which is applicable to a variety of ways of use.

In the multilens member of the present invention, the surface (first surface) of the second lens, which is opposed to the base member, has the junction which is to be joined to the first lens and the overhang which is allowed to overhang outwardly from the junction. In other words, the surface (first surface) of the second lens, which is opposed to the base member, is larger than the junction between the first lens and the second lens. In this arrangement, the overhang structure (roof structure) is formed at the part of the optical structural member composed of the first lens and the second lens. Therefore, it is possible to increase the light which is allowed to outgo to the outside from the first lens and which is thereafter allowed to income into the second lens again. Therefore, it is possible to enhance the effect including, for example, the prism function and the lens function of the multilens member.

In the multilens member of the present invention, an angle, which is formed by the overhang of each of the second lenses and the base member, may not be less than 180 degrees. In this arrangement, it is possible to increase the areal size of the overhang of the second lens as viewed from the side surface of the first lens (surface other than the surface opposed to the second lens and the base member). It is possible to increase the light (an amount of the light) which is allowed to outgo to the outside from the first lens described above and which is thereafter allowed to come into the second lens again. Most of the light outgoing from the side surface of the first lenses travels upwardly (in a direction from the base member to the second lenses). When a light traveling upwardly (upward-outgoing light, upward emission light) among the light outgoing from the side surface of the first lenses, can be entered efficiently into the second lenses, the upward emission light can be further subjected to the optical function (prism function, lens function etc.) by the second lenses. Therefore, it is possible to enhance the effect including, for example, the prism function and the lens function of whole of the multilens member. Here, when the angle, which is formed between the overhang and the base member, is not less than 180 degrees, the upward emission light never travel parallel to the overhang. Therefore, a missing-light amount of the upward emission light can be decreased, because a light which travels in parallel to the overhang to go away without entering the second lenses can be decreased. That is, when the angle, which is formed between the overhang and the base member, is not less than 180 degrees, the light, which is allowed to outgo from the side surface of the first lens and which is directed toward the second lens, is successfully allowed to come into the second lens from the overhang. Therefore, it is possible to enhance the effect including, for example, the prism function and the lens function of whole of the multilens member.

In the multilens member of the present invention, hollow spaces may be defined by the first lenses and the second lenses.

In the optical structural member composed of the first lens group and the second lens group of the multilens member of the present invention, it is possible to form the structure in which the overhang of the second lens (outer wall surface of the second lens adjacent to the junction between the first lens and the second lens) protrudes from the junction to the outside (structure in which the projection allowed to protrude to the outside is formed on the side surface of the optical structural member composed of the first lens and the second lens). That is, it is possible to form the overhang structure at the part of the side surface of the optical structural member composed of the first lens and the second lens. In particular, when the structure, in which the upper surface of the plurality of first lenses are bridged by the second lenses, is provided, the hollow spaces, which are defined by the first lenses and the second lenses, are formed at the inside of the multilens member. When the multilens member has the hollow spaces or the overhang structure of the optical structural member therein as described above, the light beam, which is allowed to come into the multilens member, can pass through the interfaces between the optical structural member and the air a plurality of times. It is possible to increase the amount of refraction of the incident light.

In the case of the optical sheet described in Japanese Patent No. 3455884 described above, the incident light can be also allowed to pass through the interfaces between the optical structural member and the air a plurality of times (refracted a plurality of times). However, generally, the incident light can be refracted only twice at the light-incoming point and the light-outgoing point of the optical sheet, except for the incident light component having an extremely shallow angle of incidence with respect to the sheet surface (angle of incidence approximately in parallel to the sheet surface). On the contrary, when the multilens member has the hollow spaces at the inside or the overhang structure of the optical structural member as in the multilens member of the present invention, the light beam can be refracted by allowing the light beam to pass through the interfaces between the optical structural member and the air three times or more, depending on the optical path of the light beam. Therefore, in the case of the multilens member of the present invention, it is possible to increase the amount of refraction of the incident light, and it is possible to improve the light-collecting performance, as compared with the optical sheet described in Japanese Patent No. 3455884 as well.

In the multilens member of the present invention, each of the second lenses may have a tapered shape which is tapered in a direction directed from the base member toward the second lens. In this arrangement, the areal size of the surface of the second lens opposed to the base member is increased. Therefore, it is possible to increase the amount of the light which is included in the light directed from the first lens toward the air and which is allowed to come into the second lens again. It is possible to enhance the light-collecting performance of the optical sheet.

In the multilens member of the present invention, the overhang of each of the second lenses may be parallel to the base member. In this arrangement, the angle, which is formed by the overhang of the second lens and the base member, is 180 degrees. In this arrangement, there is no fear that the upward emission light, which is allowed to outgo from the side surface of the first lens and which is directed toward the second lens, travels in parallel to the overhang to go away without entering the second lenses. Therefore, the upward emission light is successfully allowed to come into the second lens from the overhang. The shape of the second lens is not complicated, the multilens sheet can be produced with ease. Further, it is possible to increase the areal size of the overhang surface of the second lens as viewed from the side surface of the first lens. It is possible to enhance the light-collecting performance of the optical sheet.

In the multilens member of the present invention, the first lenses may include a plurality of first linear members which extend in a first direction, and the first linear members may be aligned in a direction perpendicular to the first direction.

In the multilens member of the present invention, the second lenses may include a plurality of second linear members which extend in a second direction, and the second linear members may be aligned in a direction perpendicular to the second direction.

In the multilens member of the present invention, the first direction may be perpendicular to the second direction

In the multilens member of the present invention, the first direction may be parallel to the second direction. For example, when both of the first lenses and the second lenses are formed with the prism-shaped structural members as described above, and the extending directions of the first lenses and the second lenses are identical with each other, then the overhang structure is formed at the part of the side surface of the optical structural member composed of the first lenses and the second lenses. In this arrangement, in particular, the light beam, which comes into the first lens obliquely, is successfully allowed to pass through the interfaces between the optical structural member (lens) and the air a plurality of times. It is possible to increase the amount of refraction of the oblique incident light. Therefore, in this arrangement, the optical member is obtained, which is more preferable for the way of use in which the incident light is required to be refracted more abruptly (for example, for the illumination apparatus having such a structure that the light beam, which is allowed to come at a shallow angle, is allowed to outgo while greatly changing the angle).

In the multilens member of the present invention, a cross section of each of the first lenses in a plane perpendicular to the first direction may have a trapezoidal shape. In this arrangement, the junction surface between the first lens and the second lens is increased. Therefore, it is easy to form the second lenses on the first lenses, and it is possible to increase the strength of the multilens member.

In the multilens member of the present invention, a cross section of each of the second lenses in a plane perpendicular to the second direction may have a triangular shape. In the multilens member of the present invention, the plurality of second lenses may be arranged such that adjacent second lenses among the plurality of second lenses are separated.

In the multilens member of the present invention, each of the first lenses may include a first structure which has a joining portion joined to one of the second lenses, and a second structure of which length is shorter than that of the first structure, the length being in a direction from the base member toward the second lenses. Further, a shape of the first structure may be substantially same as that of the second structure. It is noted that the light, which passes through the junction between the first lens and the second lens and which travels toward the second lens, undergoes the decrease in the light-collecting effect to be brought about by the first lens. Therefore, it is desirable that the junction between the first lens and the second lens has a small areal size. In relation thereto, in the case of the multilens member of the present invention, the first lens is joined to the second lens at the part thereof (first structural member). Therefore, it is possible to decrease the areal size of the junction between the first lens and the second lens, and it is possible to improve the optical performance of the multilens member, as compared with the case in which the first lens and the second lens are joined to one another in the entire structural member for constructing the first lens.

According to a second aspect of the present invention, there is provided an illumination apparatus including a light source; and a multilens member including: a base member which has light transmissivity; a plurality of first lenses which are formed on the base member; and a plurality of second lenses each of which has a first surface facing the base member and each of which is joined onto one of the first lenses at the first surface, wherein the first surface of each of the second lenses has a junction which is joined to one of the first lenses and an overhang which overhangs outwardly from the junction. The illumination apparatus of the present invention may further comprise an optical guide plate which guides light emitted from the light source to the multilens member.

According to a third aspect of the present invention, there is provided a liquid crystal display apparatus including: a liquid crystal display device; a light source; and a multilens member including: a base member which has light transmissivity; a plurality of first lenses which are formed on the base member; and a plurality of second lenses each of which has a first surface facing the base member and each of which is joined to the plurality of first lenses at the first surface, wherein the first surface of each of the second lenses has a junction which is joined to one of the first lenses and an overhang which overhangs outwardly from the junction. The liquid crystal display apparatus of the present-invention may further include an optical guide plate which guides light emitted from the light source to the multilens member.

In the illumination apparatus and the liquid crystal display apparatus of the present invention, the multilens member of the present invention described above is used as the optical member for adjusting the directivity of the light. Therefore, it is possible to realize the thin size (small size) and the low cost of the illumination apparatus and the liquid crystal display apparatus. Further, it is possible to provide the illumination apparatus in which the optical performance is improved as compared with the conventional illumination apparatus and the liquid crystal display apparatus.

According to the multilens member of the present invention, the optical structural member, which is formed by joining the first lenses and the second lenses, is formed on the base member. Therefore, it is possible to improve the optical performance.

According to the multilens member, the illumination apparatus, and the liquid crystal display apparatus of the present invention, the first lenses and the second lenses are joined to one another, and it is unnecessary to form the first lenses and the second lenses on distinct base members respectively. Therefore, it is possible to realize the thin size and the low cost of the multilens member, the illumination apparatus, and the liquid crystal display apparatus.

### BRIEF DESCRIPTION OF THE DRAWINGS

FIG. 1 shows a schematic arrangement of a backlight unit and a liquid crystal display apparatus of a first embodiment.

FIGS. 2A, 2B and 2C show a schematic arrangement of a multilens sheet of the first embodiment, wherein FIG. 2A shows a perspective view, FIG. 2B shows a side view as viewed in the Y direction shown in FIG. 2A, and FIG. 2C shows a side view as viewed in the X direction shown in FIG. 2A.

FIG. 3 shows a magnified sectional view illustrating hollow spaces in the multilens sheet of the first embodiment.

FIG. 4 shows a schematic arrangement of an apparatus for producing the multilens sheet used in the first embodiment.

FIG. 5 shows a flow chart illustrating the procedure of a method for producing the multilens sheet of the first embodiment.

FIG. 6 shows an SEM image of a cross section of the multilens sheet manufactured in the first embodiment.

FIG. 7 shows an SEM image of an upper surface of the multilens sheet manufactured in the first embodiment.

FIG. 8 shows luminance characteristics measured for backlight units constructed in the first embodiment and Comparative Example.

FIG. 9 shows a schematic arrangement of an apparatus for producing a multilens sheet used in a second embodiment.

FIG. 10 shows a flow chart illustrating the procedure of a method for producing the multilens sheet of the second embodiment.

FIG. 11 shows the procedure of a method for producing a multilens sheet of a third embodiment.

FIG. 12 shows a schematic arrangement of a multilens sheet of a fourth embodiment.

FIG. 13A shows a magnified sectional view illustrating an optical adjusting layer of the multilens sheet of the fourth embodiment, FIG. 13B shows a magnified oblique sectional view of an optical adjusting layer of the multilens sheet of the first embodiment, taken along XIIIB-XIIIB line shown in FIG. 2A, and FIG. 13C shows a magnified sectional view of a modified embodiment of the multilens sheet of the fourth embodiment.

FIGS. 14A and 14B illustrate the effect of the multilens sheet of the fourth embodiment, wherein FIG. 14A shows a situation of the refraction of the incident light in an optical structural member having no overhang structure on the side surface, and FIG. 14B shows a situation of the refraction of the incident light in the optical structural member having the overhang structure on the side surface.

FIG. 15 shows a schematic arrangement of a multilens sheet of a first modified embodiment.

FIG. 16 shows a schematic arrangement of a multilens sheet of a second modified embodiment.

FIG. 17 shows a schematic arrangement of a multilens sheet of a third modified embodiment.

FIGS. 18A and 18B shows a schematic arrangement of a multilens sheet of a fourth modified embodiment, wherein FIG. 18A shows a perspective view, and FIG. 18B shows a sectional view taken along a XVIIIB-XVIIIB line shown in FIG. 18A.

FIG. 19 shows a schematic arrangement of a multilens sheet of a fifth modified embodiment.

FIG. 20 shows a schematic arrangement of a multilens sheet of a sixth modified embodiment.

FIG. 21 shows a schematic arrangement of the conventional liquid crystal display apparatus and the conventional illumination apparatus.

FIG. 22 shows a schematic arrangement of the conventional prism sheet.

### DESCRIPTION OF THE PREFERRED EMBODIMENTS

An explanation will be specifically made below with reference to the drawings about embodiments of the multilens member, the illumination apparatus, and the liquid crystal display apparatus according to the present invention. However, the present invention is not limited thereto.

### First Embodiment

In this first embodiment, an explanation will be made about a liquid crystal display apparatus as well as an illumination apparatus and a multilens member to be used therefor.

### Arrangement of Liquid Crystal Display Apparatus and Backlight Unit

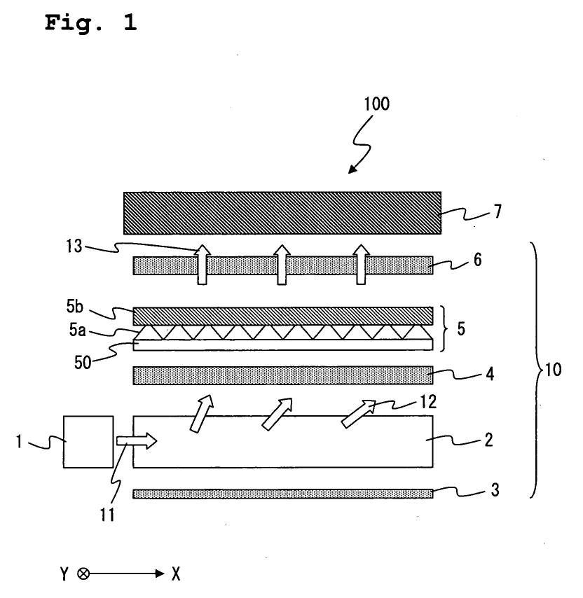

FIG. 1 shows a schematic arrangement of the liquid crystal display apparatus used in the first embodiment. In FIG. 1, the respective optical members are depicted separately in order to comprehensively understand the arrangement of the liquid crystal display apparatus. However, the respective optical members are stacked in a state of making contact with each other in the actual apparatus. As shown in FIG. 1, the liquid crystal display apparatus 100 of this embodiment comprises a liquid crystal display panel 7 (liquid crystal display device) and a backlight unit 10 (illumination apparatus).

A liquid crystal display panel used in the conventional liquid crystal display apparatus was used for the liquid crystal display panel 7. Specifically, although not shown, the structure of the liquid crystal display panel 7 was the following structure. That is, a polarizing plate, a glass substrate, a transparent conductive film for forming a pixel electrode, an orientation film, a liquid crystal layer, an orientation film, a transparent conductive film for forming an opposing electrode, a color filter, a glass substrate, and a polarizing plate were stacked in this order.

As shown in FIG. 1, the backlight unit 10 mainly includes a light source (LED: light emitting diode) 1, an optical guide plate 2 which changes the light 11 emitted or radiated from the light source 1 into the surface light source, a reflecting sheet 3 which is arranged under or below the optical guide plate 2 (on the side opposite to the liquid crystal display panel 7), a lower diffusion sheet 4 which is arranged over or above the optical guide plate 2 (on the side of the liquid crystal display panel 7), a multilens sheet 5 (multilens member) which is arranged over or above the diffusion sheet 4, and an upper diffusion sheet 6 which is arranged over or above the multilens sheet 5. The backlight unit 10 of this embodiment is the unit based on the side light system. The light source 1 is provided on the side of the optical guide plate 2.

The optical members other than the multilens sheet 10 were those which were the same as the optical members of the conventional backlight unit. Specifically, the optical guide plate 2 was formed of polycarbonate. A sheet, which was obtained by vapor-depositing silver on a surface of a PET film, was used for the reflecting sheet 3. A material, which was obtained by bead-coating a PET film, was used for the lower diffusion sheet 4, wherein the thickness was 70 μm and the haze was 85%. A material, which was obtained by bead-coating a PET film, was used for the upper diffusion sheet 6, wherein the thickness was 70 μm and the haze was 30%.

### Arrangement of Multilens Sheet

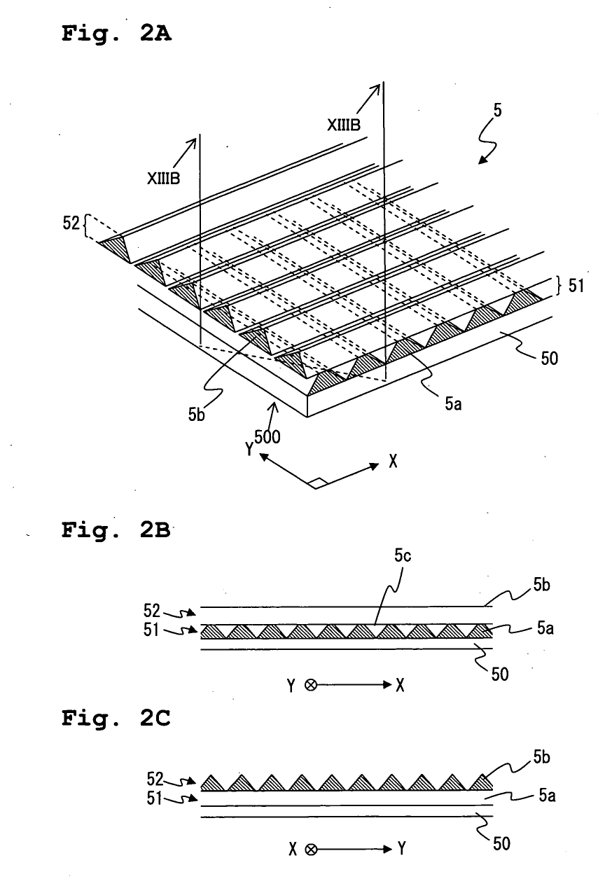

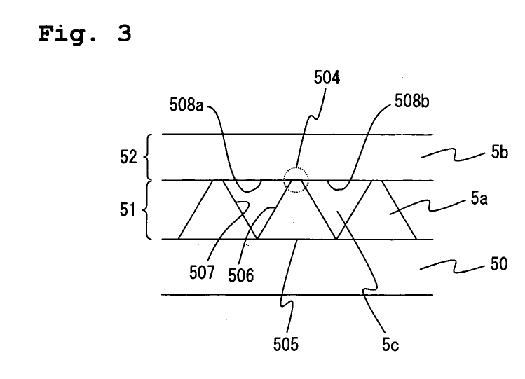

FIG. 2 shows a schematic arrangement of the multilens sheet (multilens member) 5 of this embodiment. FIG. 2A shows a perspective view illustrating the multilens sheet 5 of this embodiment. FIG. 2B shows a side view illustrating the multilens sheet 5 as viewed in the Y direction shown in FIG. 2A. FIG. 2C shows a side view illustrating the multilens sheet 5 as viewed in the X direction shown in FIG. 2A. As shown in FIGS. 2A to 2C, the multilens sheet 5 of this embodiment includes a sheet-shaped base member (base member) 50, a first optical adjusting layer 51 which is formed on the base member 50, and a second optical adjusting layer 52 which is formed on the first optical adjusting layer 51.

A polycarbonate (PC) sheet was used as the base member 50. Any arbitrary material is usable for the base member 50 of the multilens sheet 5 of the present invention, provided that the material is light transmissive. For example, acrylic resins such as polyethylene terephthalate (PET) are usable as the base member 50, other than PC. Any base member having any shape, which is not limited to only the sheet-shaped base member, is usable as the base member 50. For example, it is also allowable to use a plate-shaped base member having a thickness of about 0.5 to 100 mm, and it is also allowable to use a base member having a three-dimensional surface. When the sheet-shaped material is used as in this embodiment, it is preferable to use a sheet having a thickness of 30 to 500 μm in consideration of, for example, the easiness of the processing and the handling performance.

As shown in FIGS. 2A to 2C, the first optical adjusting layer 51 includes a plurality of first prism-shaped structures 5a (prism-shaped structural members 5a, first lenses). Each of the first prism-shaped structures 5a extends in the Y direction (first direction) as shown in FIG. 2A, which has-a trapezoidal cross section that is perpendicular to the extending direction. In the first optical adjusting layer 51, the first prism-shaped structures 5a are aligned in the X direction (second direction) as shown in FIG. 2A. The first prism-shaped structures 5a are arranged so that the adjoining prism-shaped structures 5a make contact with each other.

In this embodiment, as described later on, the first prism-shaped structures 5a were formed such that the surface of the base member 50 was directly deformed by means of the thermal transfer method. That is, the first prism-shaped structures 5a were formed of polycarbonate. Any arbitrary material is usable as the material for forming the first prism-shaped structure 5a, provided that the material is light transmissive. It is preferable to appropriately select a resin material having a refractive index of 1.3 to 2.0 depending on, for example, the optical characteristic to be required and the way of use. For example, it is possible to use transparent plastic resins including, for example, acrylic resins, urethane resins, styrene resins, epoxy resins, and silicone resins, and transparent inorganic materials, including, for example, glass. In this embodiment, the refractive index of the first prism-shaped structure 5a was 1.59.

In this embodiment, the cross-sectional shape of the first prism-shaped structure 5a was such a shape that an apex portion of an isosceles triangle having an apex angle of 50 degrees was truncated into a planar surface so that the surface was parallel to the base, i.e., a trapezoidal shape (substantially triangular shape). The width of the upper side of the trapezoidal cross section was about 6.74 μm, the width of the lower side was about 100 μm, and the height was 100 μm. The shape and the size of the cross section of the first prism-shaped structure 5a were identical (uniform) in the extending direction (Y direction) of the first prism-shaped structure 5a. That is, the first prism-shaped structure 5a was formed with a linear member having a trapezoidal prism shape. In the first optical adjusting layer 51, the first prism-shaped structures 5a were arranged at a pitch of about 100 μm on the base member 50. The size and the pitch of the first prism-shaped structure 5a are appropriately changeable depending on, for example, the optical characteristic to be required and the way of use.

As shown in FIGS. 2A to 2C, the second optical adjusting layer 52 is composed of a plurality of second prism-shaped structures 5b (second lenses). Each of the second prism-shaped structures 5b extends in the X direction (second direction) as shown in FIG. 2A, which has a triangular cross section that is perpendicular to the extending direction. That is, the second prism-shaped structures 5b and the first prism-shaped structures 5a were arranged so that the extending directions were perpendicular to one another. In the second optical adjusting layer 52, the second prism-shaped structures 5b were arranged in the Y direction (first direction) as shown in FIG. 2A. Gaps were provided between the adjoining second prism-shaped structures 5b to make no contact with each other.

In this embodiment, the second prism-shaped structure 5b was formed of an ultraviolet-curable resin. The refractive index of the second prism-shaped structure 5b was 1.53. Any arbitrary material is usable as the material for forming the second prism-shaped structure 5b, provided that the material is light transmissive in the same manner as the first prism-shaped structure 5a. It is preferable to appropriately select a resin material having a refractive index of 1.3 to 2.0 depending on, for example, the optical characteristic to be required and the usage (application).

In this embodiment, the cross-sectional shape of the second prism-shaped structure 5b was an isosceles triangle having an apex angle of 50 degrees, a width of the base of about 24 μm, and a height of about 12 μm. The shape and the size of the cross section of the second prism-shaped structure 5b were identical (uniform) in the extending direction (X direction) of the second prism-shaped structure 5b. That is, the second prism-shaped structure 5b was formed with a linear member having a triangular prism shape. The gap between the adjoining second prism-shaped structures 5b was about 5 μm, and the pitch of the second prism-shaped structures was about 29 μm.

In the multilens sheet 5 of this embodiment, as described later on, the second prism-shaped structures 5b were joined to the upper surfaces of the first prism-shaped structures 5a. Specifically, as shown in FIGS. 2A to 2C, the second prism-shaped structures 5b were joined so that the upper surfaces of the first prism-shaped structures 5a were bridged by the second prism-shaped structures 5b. When the upper surface portions of the first prism-shaped structures 5a are bridged by the second prism-shaped structures 5b in the multilens sheet 5 as described above, hollow spaces 5c, which are defined by the side wall surfaces of the first prism-shaped structures 5a and the lower surface portions of the second prism-shaped structures 5b, are formed in the multilens sheet 5 as shown in FIG. 2B.

FIG. 3 shows a magnified view illustrating those disposed in the vicinity of the hollow spaces 5c in the multilens sheet 5. As shown in FIG. 3, in the multilens sheet 5 of this embodiment, the hollow spaces 5c are defined by the side wall surfaces 506, 507 of the first prism-shaped structures 5a and the outer wall surfaces 508a of the second prism-shaped structures 5b adjacent to the junction portions 504 of the first prism-shaped structures 5a and the second prism-shaped structures 5b. In the multilens sheet 5 of this embodiment, as shown in FIG. 3, both of the angles formed between the outer wall surfaces 508a and the contact surface 505 of the first prism-shaped structures 5a, and between the outer wall surfaces 508b and the contact surface 505 are 180 degrees. The outer wall surface 508a (508b) of the second prism-shaped structures 5b is adjacent to the junction portions 504 of the first prism-shaped structures 5a and the second prism-shaped structures 5b. The contact surface 505 of the first prism-shaped structures 5a makes contact with the base member 50 (surface of the first prism-shaped structure 5a opposed to the base member 50).

As described above, in the multilens sheet 5 of this embodiment, the first prism-shaped structures 5a and the second prism-shaped structures 5b are joined to one another so that the extending direction of the first prism-shaped structures 5a is mutually perpendicular to the extending direction of the second prism-shaped structures 5b. Therefore, the function, which is the same as or equivalent to the function to be obtained by the conventional prism sheet group composed of the two prism sheets as described above, is obtained with one multilens sheet 5. In the multilens sheet 5 of this embodiment, it is possible to reduce the thickness by an amount corresponding to one sheet of the base member of the prism sheet as compared with the conventional prism sheet group. Therefore, it is possible to realize the thin size and the low cost of the optical member for the optical adjustment, the illumination apparatus including, for example, the backlight unit, and the liquid crystal display apparatus. In the multilens sheet 5 of this embodiment, it is possible to reduce the thickness by an amount corresponding to one sheet of the base member of the prism sheet as compared with the conventional prism sheet group. Therefore, it is possible to suppress the scattering and the absorption of the transmitted light, and it is possible to suppress the deterioration of the optical performance. That is, when the multilens sheet 5 of this embodiment is used, it is possible to provide the liquid crystal display apparatus and the backlight unit which are thin at the low cost, while maintaining, for example, the brightness (luminance), the field angle, and the display quality which are equivalent to or more excellent than those of the conventional technique.

### Method for Manufacturing Multilens Sheet

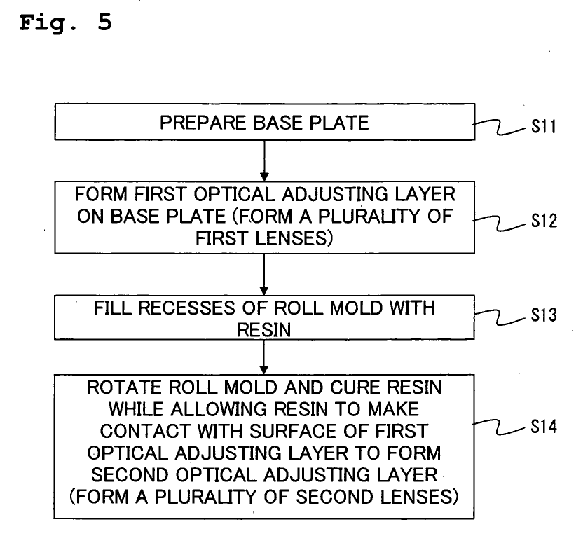

Next, a method for manufacturing the multilens sheet of this embodiment will be explained with reference to FIGS. 2, 4, and 5. FIG. 5 shows a flow chart illustrating the procedure of the method for manufacturing the multilens sheet of this embodiment.

At first, a polycarbonate sheet having a thickness of 200 μm was prepared as the base member (Step S11 shown in FIG. 5). Subsequently, the first optical adjusting layer 51 composed of the plurality of first prism-shaped structures 5a was formed on the base member 50 (Step S12 shown in FIG. 5). Specifically, the first optical adjusting layer 51 was formed as follows. At first, a mold was prepared, in which a projection-recess shape obtained by inverting the projection-recess shape to be formed on the surface of the first optical adjusting layer 51 was formed on a surface. The projection-recess surface of the mold was formed by means of the cutting processing. Subsequently, the mold was heated and pressed against the base member 50 to transfer the projection-recess shape of the mold onto the surface of the base member 50. That is, the projection-recess shape of the mold was transferred onto the surface of the base member 50 by using the thermal transfer method. In this procedure, the mold temperature was 180° C., and the pressure was 10 kg/cm². This state was maintained for 60 seconds. Subsequently, the mold was cooled to room temperature, and the base member 50 was exfoliated from the mold. In this embodiment, the first optical adjusting layer 51 (first lens group), which was composed of the plurality of prism-shaped structures 5a, was formed on the base member 50 as described above.

Subsequently, the second optical adjusting layer 52 (second lens group), which was composed of the plurality of second prism-shaped structures 5b, was formed as follows on the first optical adjusting layer 51 which was composed of the plurality of first prism-shaped structures 5a (Steps S13 and S14 shown in FIG. 5).

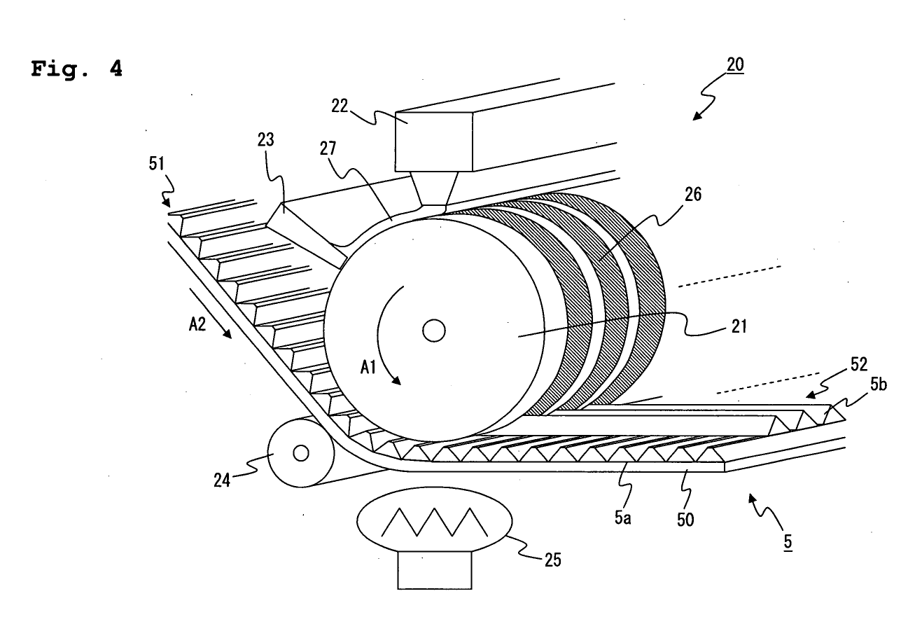

An explanation will now be made about a production apparatus used to form the second optical adjusting layer 52 including the plurality of second prism-shaped structures 5b. FIG. 4 shows a schematic arrangement of the production apparatus used to form the second optical adjusting layer 52. As shown in FIG. 4, the production apparatus 20 used to form the second optical adjusting layer 52 in this embodiment mainly includes: a roll-shaped mold 21 (hereinafter referred to as “roll mold” as well); a resin supply unit 22 which applies, to the surface of the roll mold 21, the ultraviolet-curable resin as the material for forming the second prism-shaped structures 5b; a scraping member (scraper) 23 which scrapes any unnecessary resin applied to the surface of the roll mold 21; a controlling roll 24 which is provided to control the contact state between the ultraviolet-curable resin applied to the surface of the roll mold 21 and the surface of the first optical adjusting layer 51; and an ultraviolet light radiation unit 25 which is provided to cure the ultraviolet-curable resin allowed to make contact with the first optical adjusting layer 51. As shown in FIG. 4, the controlling roll 24 and the ultraviolet light radiation unit 25 are arranged at the positions at which they are opposed to the roll mold 21 with the base member 51 intervening therebetween. The ultraviolet light radiation unit 25 is arranged on the downstream side of the controlling roll 24 (front side in the traveling direction A2 of the base member 50 as shown in FIG. 4).

A projection-recess shape, which is obtained by inverting the projection-recess shape of the surface of the second optical adjusting layer 52, is formed on the surface of the roll mold 21. In this embodiment, the cross-sectional shape of the second prism-shaped structure 5b is triangular. Therefore, a plurality of V-shaped grooves 26, each of which corresponded to the cross-sectional shape of the second prism-shaped structure 5b, were formed on the surface of the roll mold 21.

In this embodiment, the second optical adjusting layer 52, which was composed of the plurality of second prism-shaped structures 5b, was formed as follows by using the production apparatus 20 described above. At first, the base member 50, which had the first optical adjusting layer 51 formed on the surface, was installed to the production apparatus 20, and the base member 50 was fed toward the roll mold 21 (in the direction of the arrow A as shown in FIG. 4). In this procedure, as shown in FIG. 4, the base member 50 was installed so that the first optical adjusting layer 51 was opposed to the roll mold 21, and the extending direction of the first prism-shaped structures 5a of the first optical adjusting layer 51 was perpendicular to the extending direction of the V-shaped grooves 26 formed on the surface of the roll mold 21 (direction of rotation A1 of the roll mold 21 as shown in FIG. 4).

Subsequently, the ultraviolet-curable resin 27 was applied by the resin supply unit 22 to the surface of the roll mold 21 rotating in the direction of the arrow A1 as shown in FIG. 4. Any unnecessary resin of the applied ultraviolet-curable resin 27 was scraped off by the scraper 23 provided on the downstream side of the resin supply unit 22 (front side in the direction of rotation of the roll mold 21). Further, the ultraviolet-curable resin 27 was charged into the grooves 26 on the surface of the roll mold 21 (Step S13 shown in FIG. 5). Therefore, a state, in which the ultraviolet-curable rein 27 is charged into only the grooves 26 on the surface of the roll mold 21, is given on the surface of the roll mold 21 disposed on the downstream side of the scraper 23. Subsequently, as shown in FIG. 4, the ultraviolet-curable resin 27, with which the grooves 26 of the roll mold 21 were filled, was allowed to make contact with the upper surface portions of the first optical adjusting layer 51 in the area interposed between the roll mold 21 and the controller roll 24. In this procedure, in order to maintain the satisfactory contact state between the ultraviolet-curable resin 27 charged into the grooves 26 on the surface of the roll mold 21 and the upper surface portions of the first optical adjusting layer 51, the base member 50 was pressed at a predetermined pressure against the roll mold 21 by means of the controller roll 24.

Subsequently, the ultraviolet light was radiated from the ultraviolet light radiation unit 25 onto the base member 50 in such a state that the ultraviolet-curable resin 27, which had passed through the space between the roll mold 21 and the control roll 24, was allowed to make contact with the upper surface portions of the first prism-shaped structures 5a. In this procedure, the ultraviolet-curable resin 27, which is contained in the grooves 26 of the surface of the roll mold 21, is cured to form the second prism-shaped structures 5b on the first optical adjusting layer 51. Further, the lower surfaces of the second prism-shaped structures 5b are adhered and fixed to the upper surfaces of the first prism-shaped structures 5a. The optical structure, which is composed of the first prism-shaped structures 5a and the second prism-shaped structures 5b, is formed on the base member 50 (Step S14 shown in FIG. 5). Subsequently, when the base member 50, in which the lower surfaces of the second prism-shaped structures 5b are adhered and fixed to the upper surfaces of the first prism-shaped structures 5a, is allowed to pass through the area of the ultraviolet light radiation unit 25, the second prism-shaped structures 5b are exfoliated from the surface of the roll mold 21 together with the first prism-shaped structures 5a and the base member 50. In this embodiment, the second optical adjusting layer 52, which was composed of the plurality of second prism-shaped structures 5b, was formed on the first optical adjusting layer 51 as described above.

In order to exfoliate the second prism-shaped structures 5b from the surface of the roll mold 21 with ease, it is necessary that the adhesive force between the surface of the roll mold and the second prism-shaped structures 5b should be weaker than the adhesive force between the second prism-shaped structures 5b and the first prism-shaped structures 5a. For this purpose, it is preferable that the surface of the roll mold 21 is previously subjected to the mold release treatment. As for the mold release treatment, it is preferable to adopt a method in which the surface of the roll mold 21 is coated with a releasing agent including, for example, fluorine-based resin, DLC (diamond-like carbon), and inorganic matter such as TiN. In this embodiment, a coating agent of fluorine-based resin (KP-801M produced by Shin-Etsu Chemical Co., Ltd.) was added as the releasing agent to the surface of the roll mold 21.

In this embodiment, the multilens sheet 5 having the structure shown in FIG. 2A was manufactured as described above. In the method for producing the multilens sheet of this embodiment, it is unnecessary to form the first prism-shaped structures 5a and the second prism-shaped structures 5b on distinct base members respectively. Therefore, the multilens sheet can be easily manufactured at the low cost.

In the method for producing the multilens sheet of this embodiment, it is unnecessary to perform the filling agent-applying step and the washing step as compared with a manufacturing method of a third embodiment as described later on. Therefore, the method for producing the multilens sheet of this embodiment is easier and more convenient.

This embodiment is illustrative of the case in which only the second optical adjusting layer 52 was formed by using the production apparatus provided with the mold roll shown in FIG. 4. However, the present invention is not limited thereto. The production apparatus shown in FIG. 4 may be also used when the first optical adjusting layer 51 is formed on the base member 50.

### SEM Image of Multilens Sheet

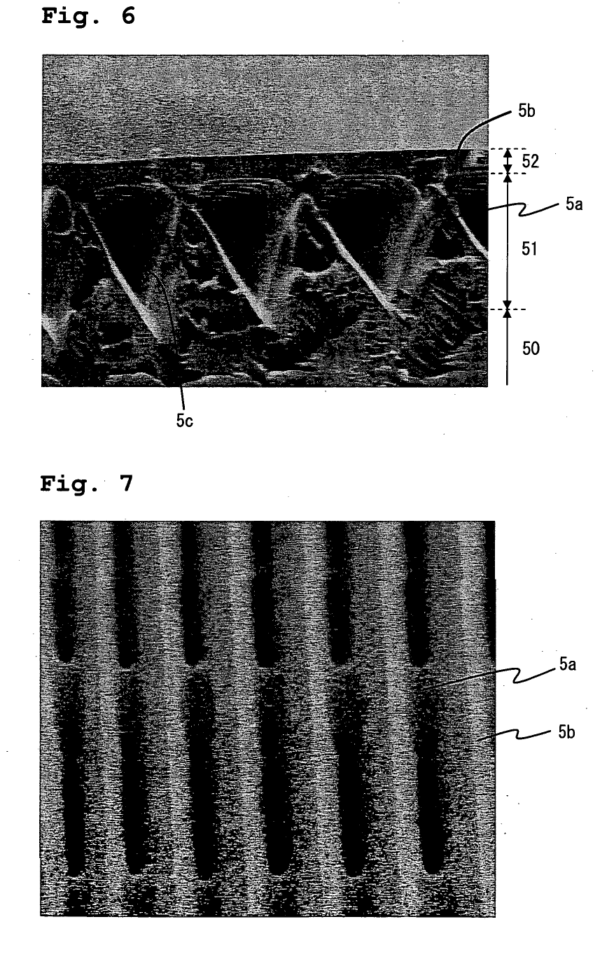

The structures of the first optical adjusting layer 51 and the second optical adjusting layer 52 of the multilens sheet 5 manufactured in this embodiment were observed by a scanning electron microscope (SEM). Obtained results are shown in FIGS. 6 and 7. FIG. 6 shows a sectional image obtained by the cutting in parallel to the extending direction of the second prism-shaped structures 5b of the multilens sheet 5. FIG. 7 shows an upper surface image of the multilens sheet 5.

As clarified from the sectional image shown in FIG. 6, the following fact is appreciated. That is, the multilens sheet 5 of this embodiment has such a structure that the upper surfaces of the first prism-shaped structures 5a and the lower surfaces of the second prism-shaped structures 5b are adhered and fixed to one another, and the upper surfaces of the first prism-shaped structures 5a are bridged by the second prism-shaped structures 5b. Further, as shown in FIG. 6, the following fact is appreciated. That is, the hollow spaces 5c, which are defined by the side surfaces of the first prism-shaped structures 5a and the lower surfaces of the second prism-shaped structures 5b, are formed in the multilens sheet 5.

In the upper surface image shown in FIG. 7, the structures, which extend in the upward-downward direction as viewed in the drawing of FIG. 7, are the second prism-shaped structures 5b. The portions, which connect the second prism-shaped structures 5b, correspond to the upper surface portions of the first prism-shaped structures 5a. As clarified from FIG. 7, the prism shapes of the second prism-shaped structures 5b are clearly observed. Further, the gaps between the second prism-shaped structures 5b are clearly observed. It has been successfully confirmed that the second prism-shaped structures 5b are formed discretely at approximately equal pitches.

### Evaluation of Optical Characteristic

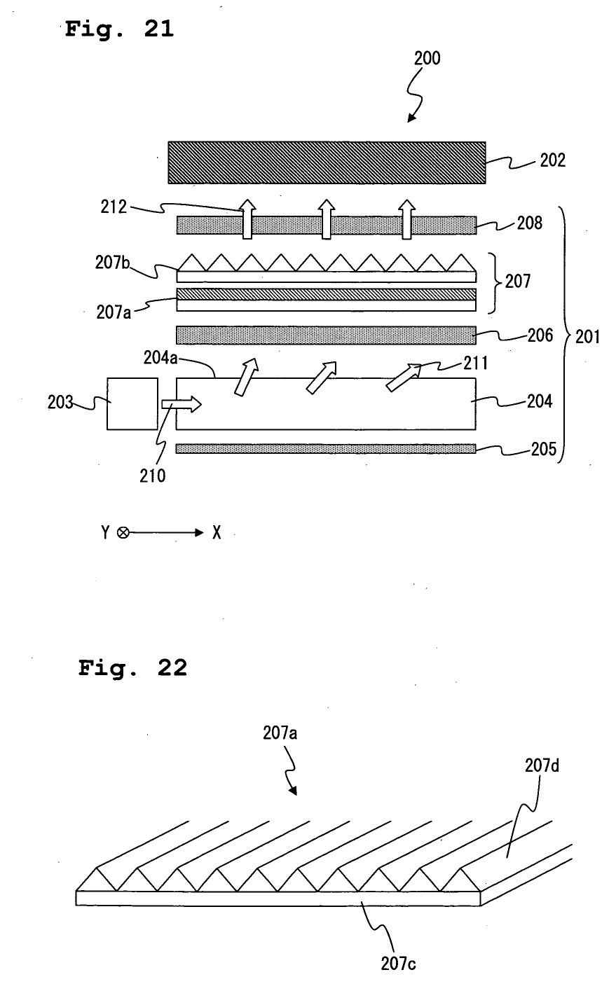

Subsequently, the backlight unit (illumination apparatus) 10 was constructed as shown in FIG. 1 by using the multilens sheet 5 manufactured in this embodiment to measure the luminance characteristic thereof. For the purpose of comparison, the luminance characteristic was also measured for a conventional backlight unit 201 (Comparative Example) shown in FIG. 21. However, the backlight unit 201 of Comparative Example was based on the use of the two conventional prism sheets (having the structure shown in FIG. 22) in place of the multilens sheet 5 of the first embodiment of the backlight unit 10 shown in FIG. 1. The optical members of the backlight unit 201 other than the above were the same as or equivalent to those of the first embodiment. The shape of the cross section perpendicular to the extending direction, which is possessed by each of the prism-shaped structures formed for the respective prism sheets of Comparative Example, was an isosceles triangle having a width of the base of 30 μm, a height of 15 μm, and an apex angle of 90 degrees.

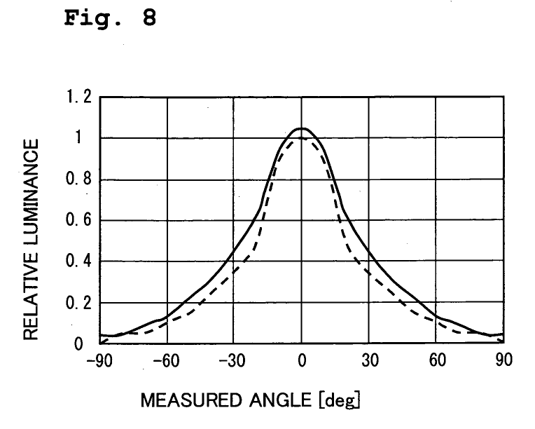

FIG. 8 shows the luminance characteristics of the backlight units of the first embodiment and Comparative Example. In FIG. 8, the horizontal axis represents the angle of measurement (measured angle) of the luminance, and the vertical axis represents the luminance ratio. The zero degree on the horizontal axis resides in the direction perpendicular to the liquid crystal display surface. The luminance ratio on the vertical axis resides in the relative luminance normalized by the front luminance of Comparative Example. In FIG. 8, the luminance characteristic of the first embodiment is represented by the solid line, and the luminance characteristic of Comparative Example is represented by the broken line. As clarified from the luminance characteristic shown in FIG. 8, the following fact has been revealed. That is, in the case of the backlight unit of the first embodiment, the front luminance ratio is about 1.05 times that of Comparative Example, and the field angle is about 48 degrees (42 degrees in Comparative Example), wherein the luminance characteristic, which is more excellent than that of Comparative Example, is obtained in any case. The field angle referred to herein means the range of the angle in which the luminance, which is not less than ½ of the maximum value of the luminance, is exhibited in the luminance characteristic. This results from the fact that the number of the base members of two can be reduced to the number of the base member of one in the multilens sheet 5 of the first embodiment as compared with the conventional prism sheet group, and thus the loss of the light is reduced.

According to the result described above, it has been revealed that the optical characteristics (for example, the brightness, the field angle, and the display quality) can be improved as compared with the conventional technique, when the multilens sheet 5 of this embodiment is used. Further, the thickness can be reduced by the amount of one sheet of the base member in the backlight unit and the liquid crystal display apparatus based on the use of the multilens sheet 5 of this embodiment. Therefore, the optical characteristics can be not only improved as compared with the conventional technique, but the backlight unit and the liquid crystal display apparatus, which are thin at the low cost, can be also obtained.

This embodiment is illustrative of the exemplary case in which the first optical adjusting layer 51 is directly formed on the surface of the base member 50 by means of the thermal transfer method. However, the present invention is not limited thereto. For example, as in the third embodiment described later on, the first optical adjusting layer 51 (the plurality of first prism-shaped structures 5a) may be formed such that the base member is allowed to make contact with a mold having a surface formed with a projection-recess shape obtained by inverting the projection-recess shape of the first optical adjusting layer 51, and the ultraviolet-curable resin is charged and cured between the mold and the base member. Alternatively, the first optical adjusting layer 51 can be also formed, for example, by means of the well-known extrusion molding method, the press molding method, and the injection molding method in which the melted resin is injected into a mold having a template of the optical structure formed therein.

The method for joining the first prism-shaped structures 5a and the second prism-shaped structures 5b is not limited to the method described above. For example, as in the second embodiment described later on, an adhesive may be applied to at least one of the lower surface portion of the second prism-shaped structure 5b subjected to the extrusion molding and the upper surface portion of the first prism-shaped structure 5a, and the first prism-shaped structure 5a and the second prism-shaped structure 5b may be formed integrally by the aid of an adhesive layer.

### Second Embodiment

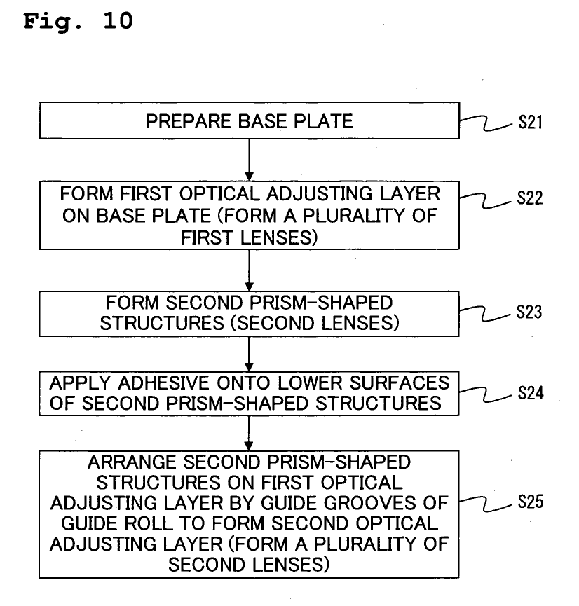

In this second embodiment, a multilens sheet, which had the same or equivalent structure (structure shown in FIG. 2) as that of the first embodiment, was manufactured. However, in this embodiment, the multilens sheet was manufactured by means of a method which was different from the method in the first embodiment. The base member, the first prism-shaped structures, and the second prism-shaped structures, which constituted the multilens sheet manufactured in this embodiment, had the same sizes as those of the first embodiment. The method for manufacturing the multilens sheet of this embodiment will be explained below with reference to FIGS. 2, 9, and 10. FIG. 10 shows a flow chart illustrating the procedure of the method for producing the multilens sheet of this embodiment.

At first, the first optical adjusting layer 51 (the plurality of first prism-shaped structures 5a) was formed on the base member 50 in the same manner as in the first embodiment (Steps S21 and S22 shown in FIG. 10). The first prism-shaped structures 5a were formed of polycarbonate in the same manner as in the first embodiment.

Subsequently, the second prism-shaped structures 5b (linear members (thread-like members, filiform members) each having a triangular prism shape) were molded by means of a method including, for example, the extrusion molding (Step S23 shown in FIG. 10). The second prism-shaped structure 5b was formed of nylon having a refractive index of 1.53. Step S23 of molding the second prism-shaped structure 5b may be performed before Steps S21 and S22 of forming the first optical adjusting layer 51. Alternatively, Step S23 of molding the second prism-shaped structure 5b may be performed during the formation of the first optical adjusting layer 51.

Subsequently, the second optical adjusting layer 52, which was composed of the plurality of second prism-shaped structures 5b, was formed on the first optical adjusting layer 51 as follows (Steps S24 and S25 shown in FIG. 10).

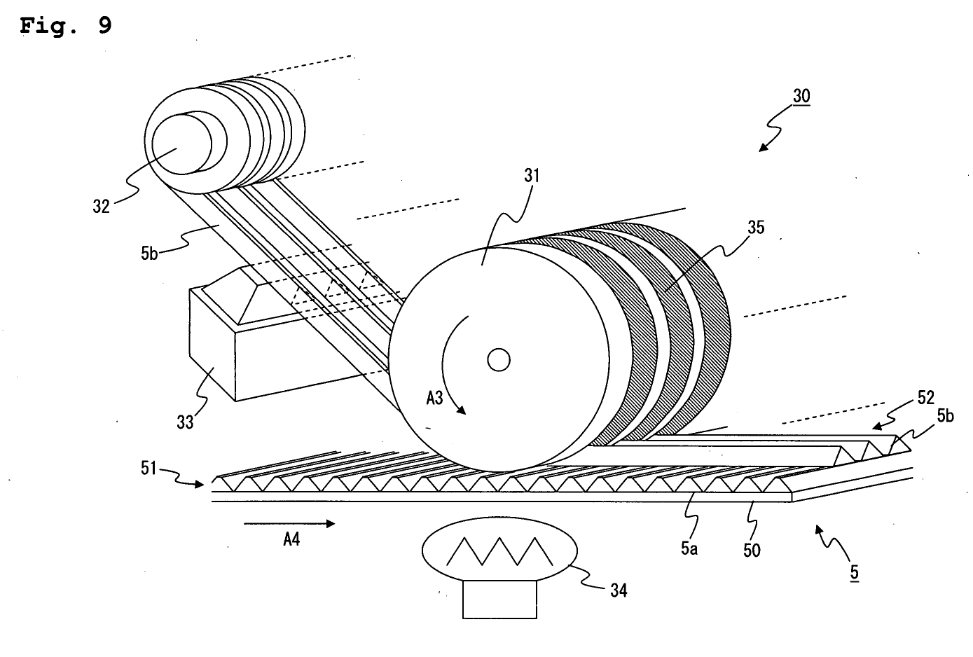

An explanation will now be made about a production apparatus of this embodiment used to form the second optical adjusting layer 52 composed of the plurality of second prism-shaped structures 5b. FIG. 9 shows a schematic arrangement of the production apparatus used to form the second optical adjusting layer 52 in this embodiment. As shown in FIG. 9, the production apparatus 30 for producing the second optical adjusting layer 52 of this embodiment mainly includes a guide roll 31, a holder 32 around which the second prism-shaped structures 5b (linear members) are wound, an adhesive-applying unit 33 which is provided to apply an adhesive to the lower surfaces of the second prism-shaped structures 5b, and an ultraviolet light radiation unit 34 which is provided to cure the adhesive. As shown in FIG. 9, the adhesive-applying unit 33 is arranged between the holder 32 and the guide roll 31. The ultraviolet light radiation unit 34 is arranged at the position opposed to the guide roll 31 with the base member 50-intervening therebetween.

In this embodiment, as shown in FIG. 9, a plurality of guide grooves 35 were formed on the surface of the guide roll 31 in order to guide the second prism-shaped structures 5b onto the first optical adjusting layer 51. The respective guide grooves 35 are formed to extend in the direction of rotation of the guide roll 31 (in the direction of the arrow A3 shown in FIG. 9). The respective guide grooves 35 are formed at predetermined spacing distances in the direction perpendicular to the direction of rotation. The spacing distance between the guide grooves 35 was slightly wider than the width of the lower surface of the second prism-shaped structure 5b. The depth of the guide groove 35 was slightly smaller than the height of the second prism-shaped structure 5b. In this embodiment, the second optical adjusting layer 52, which was composed of the plurality of second prism-shaped structures 5b, was formed on the first optical adjusting layer 51 as follows by using the production apparatus as described above.

At first, the plurality of molded second prism-shaped structures 5b were wound around the holder 32. Subsequently, as shown in FIG. 9, the second prism-shaped structures 5b were drawn from the holder 32, and the respective second prism-shaped structures 5b were inserted into the corresponding guide grooves 35 of the guide roll 31 respectively. In this procedure, the second prism-shaped structures 5b were allowed to pass along the adhesive-applying unit 33 arranged-between the holder 32 and the guide roll 31 to apply the adhesive to the lower surfaces of the second prism-shaped structures 5b (Step S24 shown in FIG. 10). In this embodiment, an ultraviolet-curable resin was used as the adhesive. However, the present invention is not limited thereto. Those usable as the adhesive other than the ultraviolet-curable resin include, for example, thermosetting and pressure-sensitive adhesives as well as instantaneous adhesives (cyanoacrylate).

Subsequently, the base member 50, on which the first optical adjusting layer 51 had been formed, was installed to the production apparatus 30, and the base member 50 was fed toward the guide roll 31 (in the direction of the arrow A4 shown in FIG. 9). In this procedure, as shown in FIG. 9, the base member 50 was installed so that the first optical adjusting layer 51 was opposed to the guide roll 31, and the extending direction of the first prism-shaped structures 5a of the first optical adjusting layer 51 was perpendicular to the extending direction of the guide grooves 35 formed on the surface of the guide roll 31.

Subsequently, as shown in FIG. 9, the guide roll 31 was rotated in the direction of the arrow A3 shown in FIG. 9, and the base member 50 was fed in the direction of the arrow A4 shown in FIG. 9, while the plurality of second prism-shaped structures 5b were arranged on the first prism-shaped structures 5a. In this situation, the ultraviolet light was radiated from the ultraviolet light radiation unit 34 through the base member 50, and the adhesive, which was applied to the lower surfaces of the second prism-shaped structures 5b, was cured to adhere the lower surfaces of the second prism-shaped structures 5b to the upper surfaces of the first prism-shaped structures 5a. In this embodiment, the second prism-shaped structures 5b and the first prism-shaped structures 5a were joined to one another as described above, and the second optical adjusting layer 52 was formed on the first optical adjusting layer 51 (Step S25 shown in FIG. 10). This embodiment is illustrative of the exemplary case in which only the second optical adjusting layer 52 was formed by using the production apparatus 30 shown in FIG. 9. However, the present invention is not limited thereto. The production apparatus 30 shown in FIG. 9 may be also used when the first optical adjusting layer 51 is formed on the base member 50.

In this embodiment, the multilens sheet 5 having the structure shown in FIG. 2A was manufactured as described above. Also in the method for producing the multilens sheet of this embodiment, it is unnecessary to form the first prism-shaped structures 5a and the second prism-shaped structures 5b on distinct base members. Therefore, the multilens sheet can be manufactured easily at the low cost in the same manner as in the first embodiment. The optical characteristic was also evaluated for the multilens sheet manufactured in this embodiment, in the same manner as in the first embodiment. As a result, the result, which was the same as or equivalent to that of the first embodiment, was obtained.

In the backlight unit and the liquid crystal display apparatus based on the use of the multilens sheet 5 of this embodiment, the optical characteristic can be not only improved as compared with the conventional technique, but the thickness can be also reduced by the thickness corresponding to one sheet of the base member. Therefore, the backlight unit and the liquid crystal display apparatus, which are thin at the low cost, are obtained.

### Third Embodiment

In this third embodiment, a multilens sheet, which had the same or equivalent structure (structure shown in FIG. 2) as that of the first embodiment, was manufactured. However, in this embodiment, the multilens sheet was manufactured by means of a method which was different from the methods adopted in the first and second embodiments. In this embodiment, the sizes and the materials for forming the base member, the first prism-shaped structures, and the second prism-shaped structures for constructing the multilens sheet were changed from those of the first and second embodiments.

A polyethylene terephthalate (PET) sheet having a thickness of 50 μm was used as the base member 50.

The first prism-shaped structures 5a were formed of an ultraviolet-curable resin. The first prism-shaped structure 5a had a refractive index of 1.59. The cross-sectional shape of the first prism-shaped structure 5a was such a shape that an apex portion of an isosceles triangle having an apex angle of 90 degrees was truncated into a planar surface so that the surface was parallel to the base, i.e., a trapezoidal shape (substantially a triangular shape). The width of the upper side of the cross section was about 8 μm, the width of the lower side was about 40 μm, and the height was about 16 μm. The shape and the size of the cross section of the first prism-shaped structure 5a was identical (uniform) in the extending direction (Y direction) of the first prism-shaped structure 5a. That is, the first prism-shaped structure 5a was formed with a linear member having a trapezoidal prism shape. In the first optical adjusting layer 51, the first prism-shaped structures 5a were arranged at a pitch of about 40 μm on the base member 50. The size and the pitch of the first prism-shaped structure 5a are appropriately changeable depending on, for example, the optical characteristic to be required and the way of use. However, in the production method of this embodiment, it is preferable that the size of the first prism-shaped structure 5a is designed so that the pitch of the first prism-shaped structure 5a is within a range of 7 to 50 μm, in consideration of the processability (easiness of the processing) of the second prism-shaped structure 5b as described later on.

The second prism-shaped structures 5b were formed of the same or equivalent material as that of the first prism-shaped structures 5a. The second prism-shaped structure 5b had a refractive index of 1.59. The cross-sectional shape of the second prism-shaped structure 5b was an isosceles triangle having an apex angle of 90 degrees, a width of the lower side of about 30 μm, and a height of about 15 μm. The shape and the size of the cross section of the second prism-shaped structure 5b was identical (uniform) in the extending direction (X direction) of the second prism-shaped structure 5b. That is, the second prism-shaped structure 5b was formed with a linear member having a triangular prism shape. The gap between the adjoining second prism-shaped structures 5b was about 5 μm, and the pitch of the second prism-shaped structures 5b was about 35 μm.

### Method for Manufacturing Multilens Sheet

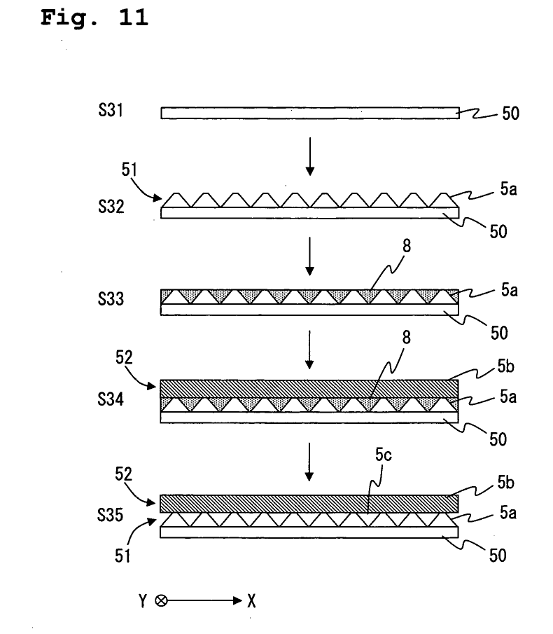

Next, an explanation will be made with reference to FIG. 11 about a method for manufacturing the multilens sheet 5 of this embodiment. At first, the base member 50 is prepared (Step S31 shown in FIG. 11). Subsequently, the first optical adjusting layer 51, which was composed of the plurality of first prism-shaped structures 5a, was formed on the base member 50 (Step S32 shown in FIG. 11). Specifically, the first optical adjusting layer 51 was formed as follows. At first, a mold (not shown), which had a surface formed with a projection-recess shape obtained by inverting the projection-recess shape to be formed on the surface of the first optical adjusting layer 51, was prepared, and the projection-recess surface of the mold was opposed to the base member 50. Subsequently, the ultraviolet-curable resin was charged into the space between the projection-recess surface of the mold and the base member 50, and the mold was pressed against the surface of the base member 50. The charged ultraviolet-curable resin was cured by radiating the ultraviolet light, and then the mold was exfoliated from the base member 50. In this embodiment, the first optical adjusting layer 51, which was composed of the plurality of first prism-shaped structures 5a, was formed on the base member 50 as described above. The projection-recess surface of the mold was formed by means of the cutting processing.

Subsequently, an aqueous solution of 10% polyvinyl alcohol (PVA, filler) was applied onto the first optical adjusting layer 51, followed by being dried and cured. After that, the surface applied with PVA was wiped with water to expose the upper surface portions of the first prism-shaped structures 5a. PVA was charged into the recesses of the first optical adjusting layer 51 as described above (Step S33 shown in FIG. 11). If necessary, the surface applied with the filler may be wiped with an appropriate solvent or polished after charging the filler into the recesses of the first optical adjusting layer 51 to expose the upper surface portions of the first prism-shaped structures 5a.

Subsequently, the second optical adjusting layer 52, which was composed of the plurality of second prism-shaped structures 5b, was formed on the first optical adjusting layer 51 (Step S34 shown in FIG. 11). Specifically, the second optical adjusting layer 52 was formed as follows. At first, a mold (not shown), which had a surface formed with a projection-recess shape obtained by inverting the projection-recess shape of the surface of the second optical adjusting layer 52, was prepared, and the projection-recess surface of the mold was opposed to the surface of the first optical adjusting layer 51 filled with PVA. In this procedure, the projection-recess surface of the mold was opposed to the surface of the first optical adjusting layer 51 so that the extending direction of the first prism-shaped structures 5a of the first optical adjusting layer 51 was perpendicular to the extending direction of the recesses of the mold (portions corresponding to the second prism-shaped structures 5b). Subsequently, the space between the projection-recess surface of the mold and the first optical adjusting layer 51 was filled with the ultraviolet-curable resin. Subsequently, the mold was pressed at a sufficient pressure against the surface of the first optical adjusting layer 51 so that no ultraviolet-curable resin remained between the recesses of the mold (portions corresponding to the gaps between the second prism-shaped structures 5b) and the surface of the first optical adjusting layer 51. The charged ultraviolet-curable resin was cured by radiating the ultraviolet light, and then the mold was exfoliated from the base member 50. In this embodiment, the second optical adjusting layer 52, which was composed of the plurality of second prism-shaped structures 5b, was formed on the first optical adjusting layer 51 as described above. In this procedure, the upper surfaces of the first prism-shaped structures 5a of the first optical adjusting layer 51 are adhered or fused to the lower surfaces of the second prism-shaped structures 5b of the second optical adjusting layer 52, and the first prism-shaped structures 5a and the second prism-shaped structures 5b are joined to one another.

When the upper surface portions of the first prism-shaped structures 5a are made flat as described above, the junction surfaces (adhesion surfaces or fusion surfaces) of the first prism-shaped structures 5a and the second prism-shaped structures 5b are widened. Therefore, the second prism-shaped structures 5b can be fixed onto the first prism-shaped structures 5a stably.

Subsequently, the multilens sheet 5, which was manufactured as described above, was immersed in water to apply the ultrasonic wave, and thus the filler (PVA) having been contained in the multilens sheet 5 was removed (Step S35 shown in FIG. 11). In the multilens sheet 5 of this embodiment, the gaps are provided between the second prism-shaped structures 5b, and hence the filler makes contact with water via the gaps. Therefore, the filler is easily removed in this structure. Subsequently, the filler was sufficiently removed, and then the multilens sheet 5 was dried. In this embodiment, the filler is removed with the solvent as described above. Therefore, it is preferable that a material, which is easily dissolved in a solvent that does not corrode any one of the base member 50 and the respective optical adjusting layers 51, 52, is used as the filler. Those usable may include, for example, PVA, polyvinyl pyrrolidone, pullulan produced by Hayashibara Co., Ltd., and alcohol-soluble nylon.

In this embodiment, the multilens sheet 5 was manufactured as described above. In the method for producing the multilens sheet 5 of this embodiment, it is unnecessary to form the first prism-shaped structures 5a and the second prism-shaped structures 5b on distinct base members respectively. Therefore, the multilens sheet can be manufactured easily at the low cost.

The method for forming the first optical adjusting layer 51 is not limited to the method of this embodiment described above. It is also possible to form the first optical adjusting layer 51 by deforming the base member 50 itself. For example, the thermal transfer method is also available such that a mold, which has a surface formed with a projection-recess shape obtained by inverting the projection-recess shape of the first optical adjusting layer 51, may be heated, and the mold may be pressed against the base member 50 to transfer the projection-recess shape of the mold to the base member, in the same manner as in the first embodiment. Alternatively, the first optical adjusting layer 51 can be also formed by means of the well-known extrusion molding method, the press molding method, and the injection molding method in which a melted resin is injected into a mold having a template of the optical structure formed therein.

The method for joining the first prism-shaped structures 5a and the second prism-shaped structures 5b is not limited to the-method of this embodiment described above as well. For example, as in the second embodiment, the second prism-shaped structures 5b may be manufactured by means of the method including, for example, the extrusion molding, the adhesive may be applied to at least one of the upper surface portions of the first prism-shaped structures 5a and the lower surface portions of the second prism-shaped structures 5b, and the first prism-shaped structures 5a and the second prism-shaped structures 5b may be joined to one another by the aid of the adhesive.

In this embodiment, the second optical adjusting layer 52 is formed in the same manner as the first optical adjusting layer 51. However, the present invention is not limited thereto. Another method for forming the second optical adjusting layer 52 is available. That is, it is also allowable to use, for example, the thermal transfer method in which a thermoplastic resin is dissolved and applied onto the first optical adjusting layer 51 to form a resin layer beforehand, and a heated mold is pressed against the resin layer to transfer a projection-recess shape of the mold. It is also possible to form the second optical adjusting layer 52 by means of, for example, the well-known extrusion molding method and the press molding method.

This embodiment is illustrative of the exemplary case in which the multilens sheet is immersed in the solvent to perform the ultrasonic washing when the filler is removed. However, the present invention is not limited thereto. For example, it is also allowable that the ultrasonic washing is not performed. Further, it is also allowable to perform the temperature regulation, for example, such that the solvent is heated to a predetermined temperature.

### Evaluation of Optical Characteristic

Subsequently, the optical characteristic was also evaluated for the multilens sheet 5 manufactured in this embodiment in the same manner as in the first embodiment. As a result, in the backlight unit of the third embodiment, the front luminance ratio was about 1.15 times that of the backlight unit of Comparative Example explained in the first embodiment, and the field angle was about 50 degrees as well. The luminance characteristic, which was more excellent than that of Comparative Example, was obtained.

### Fourth Embodiment

In this fourth embodiment, a multilens sheet was manufactured, in which the extending direction of first prism-shaped structures (first lenses) of a first optical adjusting layer was the same as the extending direction of second prism-shaped structures (second lenses) of a second optical adjusting layer.

The multilens sheet 40 of this embodiment was manufactured in the same manner as in the third embodiment. However, when the second optical adjusting layer 43, which was composed of the plurality of second prism-shaped structures 45, is formed on the first optical adjusting layer 42 (Step S34 shown in FIG. 11), the second optical adjusting layer 43 was formed so that the extending direction of the first prism-shaped structures 44 was the same as the extending direction of the second prism-shaped structures 45. Other than the above, the multilens sheet 40 of this embodiment was manufactured in the same manner as in the third embodiment.

### Arrangement of Multilens Sheet

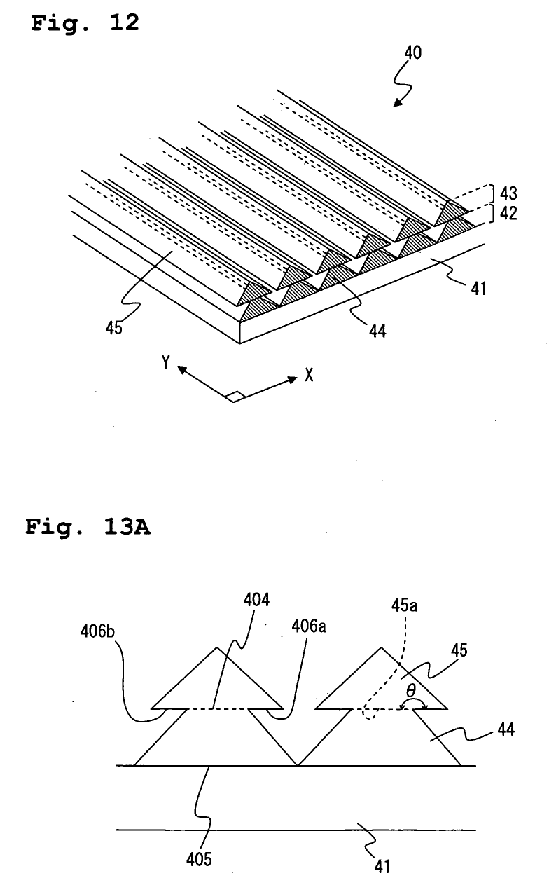

FIG. 12 shows a schematic arrangement of a multilens sheet of this embodiment. FIG. 12 shows a perspective view illustrating the multilens sheet 40 of this embodiment. As shown in FIG. 12, the multilens sheet 40 of this embodiment includes a sheet-shaped base member 41, the first optical adjusting layer 42 which is formed on the base member 41, and the second optical adjusting layer 43 which is formed on the first optical adjusting layer 42. A base member (PET sheet), which was the same as or equivalent to that of the first embodiment, was used as the base member 41. In this embodiment, the upper surfaces of the first prism-shaped structures 44 and the lower surfaces of the second prism-shaped structures 45 are joined to one another by means of the adhesion or the fusion.

As shown in FIG. 12, the first optical adjusting layer 42 has the plurality of first prism-shaped structures 44 (first lenses) which extend in the Y direction (first direction) as shown in FIG. 12 and each of which has a trapezoidal cross section perpendicular to the extending direction. In the first optical adjusting layer 42, the first prism-shaped structures 44 are aligned in the X direction (second direction) as shown in FIG. 12. The adjoining first prism-shaped structures 44 make contact with each other.

The first prism-shaped structure 44 was formed of the ultraviolet-curable resin in the same manner as in the first embodiment. The refractive index of the first prism-shaped structure 44 was 1.58. In this embodiment, the trapezoidal cross section of the first prism-shaped structure 44 had the following size or dimension. That is, both of the bottom angles were 70 degrees, the width of the upper side was about 11.8 μm, the width of the lower side was about 30 μm, and the height was about 25 μm. The shape and the size of the cross section of the-first prism-shaped structure 44 was identical (uniform) in the extending direction (Y direction) of the first prism-shaped structure 44. That is, the first prism-shaped structure 44 was formed with a linear member having a trapezoidal prism shape. In the first optical adjusting layer 42, the first prism-shaped structures 44 were aligned at a pitch of about 30 μm. When the cross section of the first prism-shaped structure 44 is trapezoidal as in this embodiment, the junction surface is increased between the first prism-shaped structure 44 and the second prism-shaped structure 45 as described later on. Therefore, the second prism-shaped structure 45 is formed with ease. Further, it is possible to increase the strength of the multilens sheet 40.

As shown in FIG. 12, the second optical adjusting layer 43 has the plurality of prism-shaped structures 45 (second lenses) which extend in the Y direction (second direction) as shown in FIG. 12 and each of which has a triangular cross section perpendicular to the extending direction. In the second optical adjusting layer 43, the second prism-shaped structures 45 were aligned in the X direction as shown in FIG. 12, and they are formed approximately just over or above the first prism-shaped structures 44. In this embodiment, as shown in FIG. 12, the width of the lower surface of the second prism-shaped structure 45 was narrower than the width of the lower surface of the first prism-shaped structure 44. The gaps were provided between the adjoining second prism-shaped structures 45 so that they make no contact with each other.

A material for forming the second prism-shaped structure 45 was the same as or equivalent to that of the first prism-shaped structure 44. The refractive index of the second prism-shaped structure 45 was 1.58. In this embodiment, the triangular cross section of the second prism-shaped structure 45 was a regular triangle (i.e., all of the three angles including the apex angle were 60 degrees) in which the width of the lower surface was about 27 μm (height was about 23.4 μm). The shape and the size of the cross section of the second prism-shaped structure 45 were identical (uniform) in the extending direction (Y direction) of the second prism-shaped structure 45. That is, the second prism-shaped structure 45 was formed with a linear member having a triangular prism shape. The gap between the adjoining second prism-shaped structures 45 was about 30 μm.

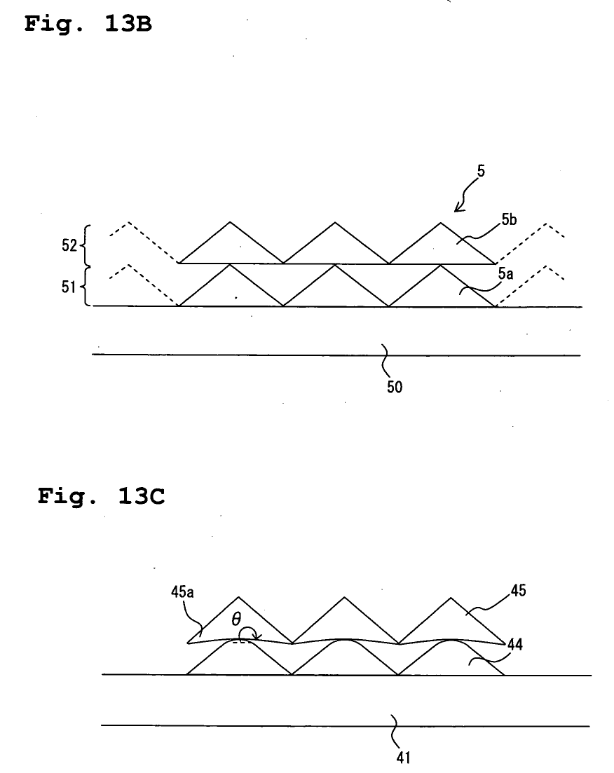

FIG. 13A shows a magnified side view as viewed in the Y direction as shown in FIG. 12, illustrating the first optical adjusting layer 42 and the second optical adjusting layer 43 of this embodiment. As shown in FIG. 13A, the multilens sheet 40 of this embodiment has such a structure that the outer wall surfaces 406a, 406b of the second prism-shaped structure 45, which are adjacent to the junction portion 404 of the first prism-shaped structure 44 and the second prism-shaped structure 45, protrude to the outside from the junction portion 404. That is, in the multilens sheet 40 of this embodiment, the overhang structure is formed at a part of the side surface of the optical structure composed of the first prism-shaped structures 44 and the second prism-shaped structures 45. In this embodiment, the angle 0, which is formed between each of the outer wall surfaces 406a, 406b (overhang portion) of the second prism-shaped structure 45 and the surface 405 of the first prism-shaped structure 44 is 180 degrees , the outer wall surfaces 406a, 406b being adjacent to the junction portion 404 of the first prism-shaped structure 44 and the second prism-shaped structure 45, and the surface 405 being opposed to the base member 41. In this arrangement, the areal size of the surface 45a of the second prism-shaped structure 45 opposed to the base member 41 is larger than the areal size of the junction portion 404 of the first prism-shaped structure 44 and the second prism-shaped structure 45. In this arrangement, the cross-sectional shape of the optical structure composed of the first prism-shaped structure 44 and the second prism-shaped structure 45 shown in FIG. 13A has a tree-like shape (hereinafter referred to as “tree-shaped optical structure” or “roof-shaped optical structure” as well), when the angle θ, which is formed between each of the outer wall surfaces 406a, 406b (overhang portion) of the second prism-shaped structure 45 and the surface 405 of the first prism-shaped structure 44 opposed to the base member 41, is not less than 180 degrees, the outer wall surfaces 406a, 406b being adjacent to the junction portion 404 of the first prism-shaped structure 44 and the second prism-shaped structure 45. It is possible to increase the areal size of the outer wall surface 406a, 406b (areal size of the overhang portion) as viewed from the side surface of the first optical structure 44. Therefore, it is possible to enhance the refraction effect of the optical structure having the overhang structure as described later on.

An explanation will be made with reference to FIGS. 14A and 14B about the effect in the multilens sheet 40 having the overhang structure at the part of the side surface of the optical structure as described above. FIG. 14A shows a situation of the refraction with respect to the oblique incident light in an optical structure having no overhang structure at a part of the side surface. FIG. 14B shows a situation of the refraction with respect to the oblique incident light in the optical structure having the overhang structure at the part of the side surface as in this embodiment.

When the overhang structure is not provided at the part of the side surface of the optical structure, the oblique incident light 47 as shown in FIG. 14A is allowed to pass only once through the interface between the optical structure 46 and the air (refracted only once). However, when the overhang structure is provided at the part of the side surface of the optical structure as in this embodiment, as shown in FIG. 14B, the oblique incident light 47 may be allowed to pass a plurality of times through the interfaces between the optical structure and the air (may be refracted a plurality of times). Therefore, when the overhang structure is provided at the part of the side surface of the optical structure as in this embodiment, then it is possible to increase the amount of refraction for the oblique incident light 47 as shown in FIG. 14B, and it is possible to improve the light-collecting performance. The optical member is obtained, which is more preferable for the way of use in which it is necessary to refract the incident light more suddenly or abruptly. For example, the optical member is preferable for the illumination apparatus such as the backlight in which the optical member directs the outgoing light, from the optical waveguide plate or the light source, at the normal direction of the sheet surface, the optical waveguide plate or the light source having a large amount of outgoing light components extremely inclined with respect to the normal direction of the sheet surface (the angle, at which the maximum value of the luminance of the outgoing light is provided, is not less than 45 degrees from the normal line direction of the sheet surface).

The optical structure having the overhang structure as described above is not limited to the multilens sheet having the first prism-shaped structures 44 and the second prism-shaped structures 45 which extend in the identical direction as in the multilens sheet 40 shown in FIG. 12. For example, it is possible to affirm the fact that the multilens sheet 5 shown in FIG. 2A also includes the optical structure having the overhang structure. A situation is now assumed, in which the light 500 shown in FIG. 2A is allowed to come into the multilens sheet 5. As shown in FIG. 13B, the cross section of the multilens sheet 5, which is taken along the plane including the traveling direction of the light 500, has the overhang structure as described above. In this way, the optical structure includes the first and the second prism-shaped structures, and the cross section of the optical structure, taken along the plane including the light-traveling direction (plane parallel to the incident light), has the overhang structure. Therefore, the light, which is allowed to come in the direction, can undergo the effect of the multiple times of refraction in the multilens sheet having the overhang structure as described above. In the multilens sheet 40 shown in FIG. 12, for example, the surface 45a of the second prism-shaped structure 45, which is opposed to the base member 41, is not necessarily parallel to the base member 41. For example, as shown in FIG. 13C, even when the surface 45a is a curved surface which is convex upwardly, it is possible to realize the tree structure (tree-shaped optical structure) and the overhang structure as described above. In this case, the outer wall surfaces of the second prism-shaped structure, which are adjacent to the junction portion, are inclined toward the first prism-shaped structure. Therefore, the angle 0 described above is not less than 180 degrees.

A method may be also conceived to increase the amount of refraction with respect to the oblique incident light, in which a plurality of optical sheets having no overhang structure are stacked and used on a part of the side surface of the optical structure as shown in FIG. 14A. However, in the case of such an optical sheet group constructed as described above, the number of optical sheets is increased as compared with the multilens sheet of this embodiment. Therefore, the thickness of the optical member is increased, the scattering and the absorption of the transmitted light are increased, and the optical performance is deteriorated.

### First Modified Embodiment

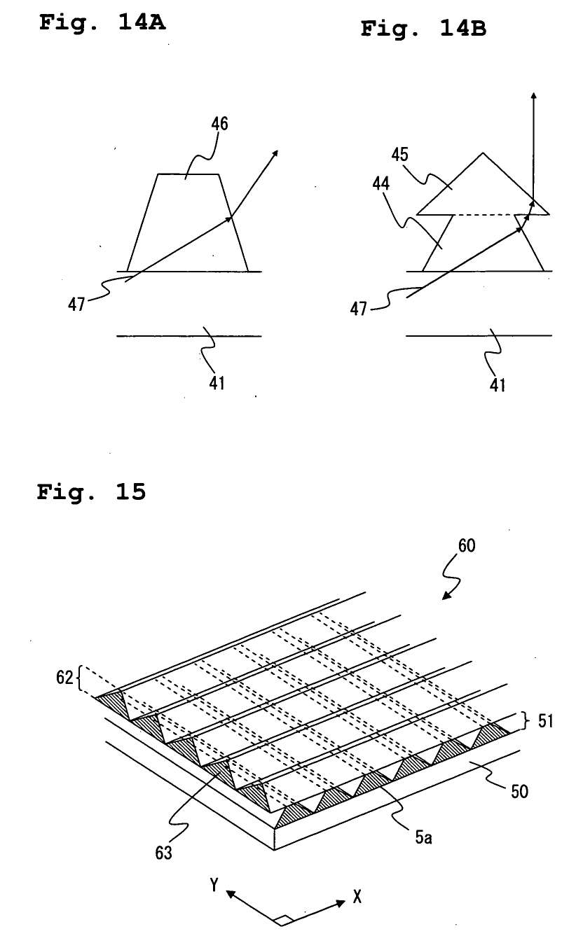

The first to third embodiments described above are illustrative of the exemplary case in which the gaps are provided between the adjoining second prism-shaped structures in the second optical adjusting layer. However, the present invention is not limited thereto. The adjoining second prism-shaped structures may make contact with each other. FIG. 15 shows an example of such an arrangement. A multilens sheet 60 shown in FIG. 15 is a modified embodiment of the multilens sheet 5 of the first embodiment, which has such a structure that adjoining second prism-shaped structures 63 make contact with each other in a second optical adjusting layer 62. Other than the above, the structure is the same as or equivalent to that of the first embodiment. The multilens sheet 60 as shown in FIG. 15 can be easily manufactured, for example, by means of the production method as explained in the first embodiment.

### Second Modified Embodiment

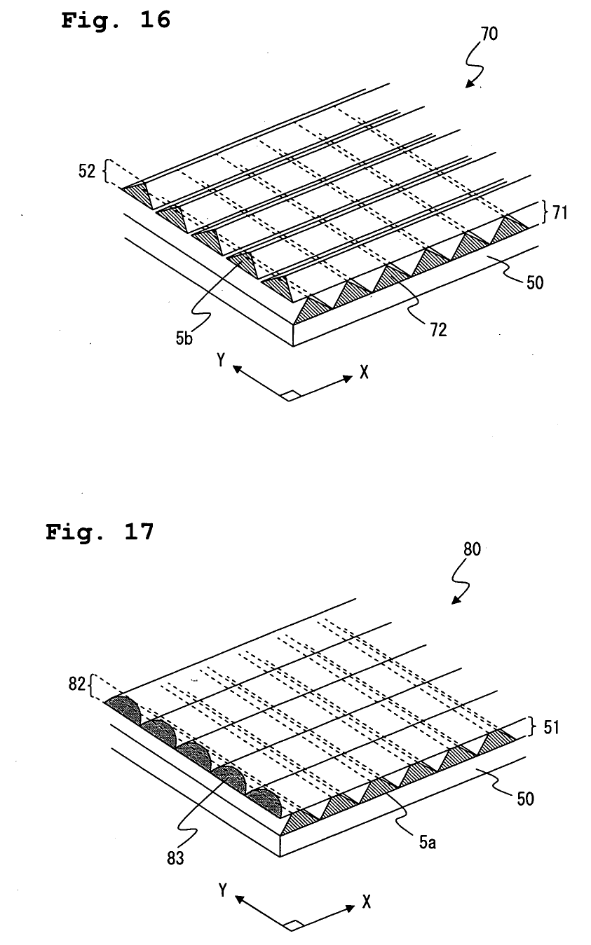

The first to third embodiments described above are illustrative of the exemplary case in which the prism-shaped structure, which has the trapezoidal cross section, is used as the first optical structure for constructing the first optical adjusting layer. However, the present invention is not limited thereto. A prism-shaped structure having a triangular cross section may be used as the first optical structure. FIG. 16 shows an example of such an arrangement. A multilens sheet 70 shown in FIG. 16 is a modified embodiment of the multilens sheet 5 of the first embodiment, wherein a linear member having a triangular cross section is used as a first prism-shaped structure 72 for constructing a first optical adjusting layer 71. Other than the above, the structure is the same as or equivalent to that of the first embodiment. The multilens sheet 70 of the second modified embodiment can be easily manufactured, for example, by means of the production method as explained in the first to third embodiments.

### Third Modified Embodiment

The first to third embodiments described above are illustrative of the exemplary case in which the linear member having the trapezoidal cross section is used as the first optical structure for constructing the first optical adjusting layer and the linear member having the triangular cross section is used as the second optical structure for constructing the second optical adjusting layer. However, the present invention is not limited thereto. The cross-sectional shapes of the first optical structure and the second optical structure can be appropriately changed depending on, for example, the optical characteristic to be required and the way of use. For example, one of the first optical structure and the second optical structure may be formed with a lens-shaped structure having a semicircular cross section. An example of such an arrangement is shown in FIG. 17. A multilens sheet 80 shown in FIG. 17 is a modified embodiment of the multilens sheet 5 of the first embodiment, which resides in such a case that an optical structure 83 for constructing a second optical adjusting layer 82 is formed with a lenticular lens-shaped structure having a semicircular cross section. The embodiment shown in FIG. 17 resides in such a structure that the adjoining lens-shaped structures 83 make contact with each other, in the same manner as in the first modified embodiment. Other than the above, the structure is the same as or equivalent to that of the first embodiment. In the case of the multilens sheet having the structure as described above, the shapes and the sizes of the first optical structure and the second optical structure can be designed independently. Therefore, the field angles in the X direction and the Y direction as shown in FIG. 17 can be established arbitrarily. In particular, when the first optical structure is the prism-shaped structure and the second optical structure is the lens-shaped optical structure as shown in FIG. 17, then the field angle in the Y direction can be widely obtained with respect to the X direction.

The second optical adjusting layer 82 as shown in FIG. 17 can be formed by appropriately changing the shape of the projection-recess surface of the mold to be used when the second optical adjusting layer 82 is formed, in the production method as explained in the first to third embodiments described above. FIG. 17 is illustrative of the exemplary case in which the second optical adjusting layer is composed of the plurality of lens-shaped structures. However, the present invention is not limited thereto. The first optical adjusting layer may be composed of a plurality of lens-shaped structures, and the second optical adjusting layer may be composed of a plurality of prism-shaped structures. Alternatively, both of the first optical adjusting layer and the second optical adjusting layer may be composed of a plurality of lens-shaped structures.

### Fourth Modified Embodiment

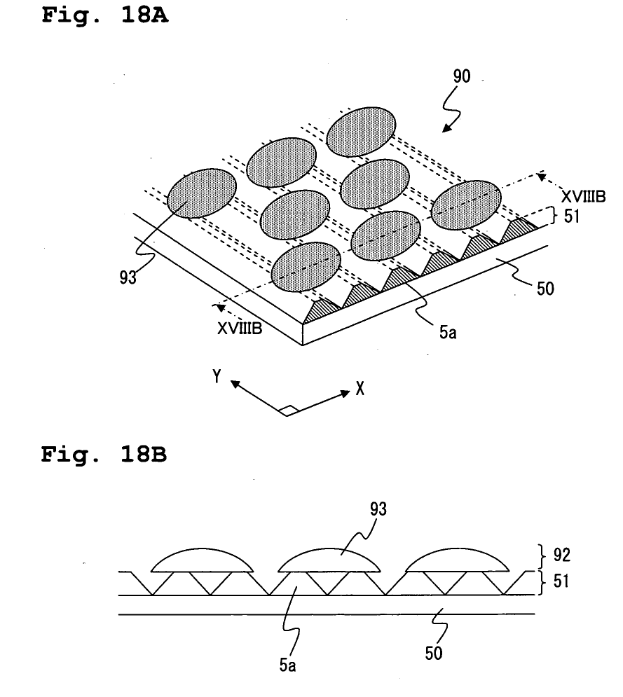

The multilens sheets of the first to fourth embodiments and the first to third modified embodiments described above are illustrative of the exemplary case in which both of the first optical structure and the second optical structure are formed with the linear members each of which has the predetermined cross-sectional shape and each of which extends in the predetermined direction. However, the present invention is not limited thereto. The first optical structure and/or the second optical structure may be formed with any member having, for example, a polygonal prism shape, a conical shape, and a semispherical (semielliptic) shape, other than the linear member. An example of such an arrangement is shown in FIGS. 18A and 18B.

A multilens sheet 90 shown in FIGS. 18A and 18B is illustrative of the case wherein a second optical adjusting layer 92, which includes a plurality of semispherical lenses 93 arranged discretely, is formed on the first optical adjusting layer 51 having the same or equivalent structure as that of the first embodiment. All of the semispherical lenses 93 had the same shape and the same size, and the semispherical lenses 93 were arranged at equal intervals. In-the case of the multilens sheet 90 having the structure as described above, it is possible to arbitrarily control the directivity of the optical characteristic. This feature will be explained more specifically. When the linear lenses (linear optical structures) are combined as the first and second optical structures as in the multilens sheets of the first to fourth embodiments and the first to third modified embodiments, the symmetry of the optical characteristic is generated on the basis of the extending direction of the linear lens. For example, when the first and second optical structures are perpendicular to one another, the symmetry of the optical characteristic is generated with respect to the X direction and the Y direction. On the contrary, when the semispherical lenses 93 are used as the second optical structures as in the multilens sheet of the fourth modified embodiment, the symmetry of the optical characteristic in the X-Y plane is enhanced by the second optical structures (symmetry is enhanced with respect to the axis in the normal line direction of the sheet surface (approximate to the axial symmetry)). As a result, it is possible to improve the symmetry of the optical characteristic of the multilens sheet. Accordingly, for example, an effect is obtained such that the dependency on the direction of the field angle characteristic can be decreased.

### Fifth Modified Embodiment

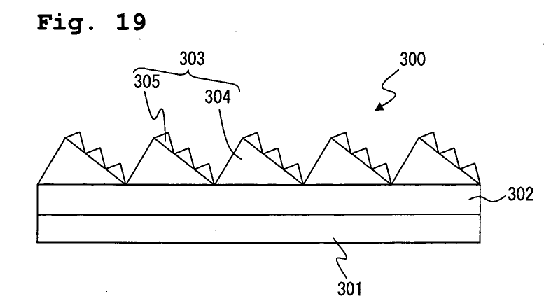

The multilens sheets of the first to fourth embodiments and the first to fourth modified embodiments described above are illustrative of the exemplary case wherein the overhang structure is provided at the part of the optical structure constructed by the first lenses and the second lenses. For example, as shown in FIG. 19, a multilens sheet 300 of the present invention may include first prism-shaped structures 302 which extend in the left-right direction as viewed in FIG. 19, and second prism-shaped structures 303 which extend in the direction perpendicular to the plane of the paper of FIG. 19, wherein the second prism-shaped structures (second lenses) 303 may include a plurality of first prism elements 304 each of which has an asymmetrical cross section (not an isosceles triangle), and a plurality of second prism elements 305 which are provided on one surface of each of the first prism elements 304 and each of which has an asymmetrical cross section. In the case of the multilens sheet 300 as shown in FIG. 19, the plurality of second prism elements 305 are provided on one surface of each of the first prism elements 304 to form the step-shaped surfaces. Accordingly, it is possible to improve the efficiency of utilization of the-incident light, and it is possible to improve the luminance. The first and the second prism elements may be provided for the first prism-shaped structures, or they may be provided for both of the first prism-shaped structures and the second prism-shaped structures.

### Sixth Modified Embodiment

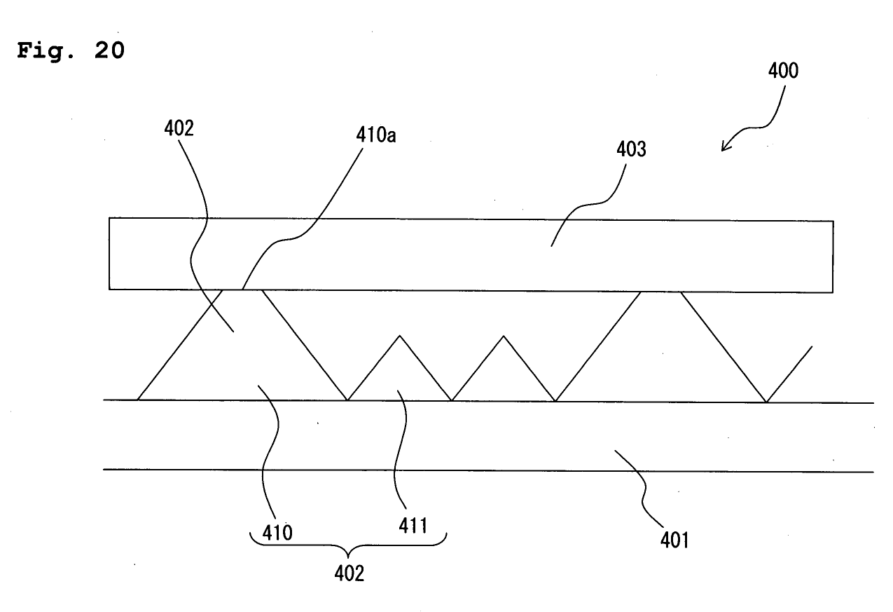

The multilens sheets of the first to fourth embodiments and the first to fourth modified embodiments described above are illustrative of the exemplary case wherein all of the first lenses have the junction portions (junction surfaces, joining portions) to be joined to the second lenses. However, the present invention is not limited thereto. The multilens sheet of the present invention may be constructed, for example, as a multilens sheet 400 shown in FIG. 20 wherein only parts of the first lenses have the junction portions to be joined to the second lenses. In this arrangement, the multilens sheet 400 has a sheet-shaped base member 401, a plurality of first prism-shaped structures 402 (first lenses) which are aligned in a predetermined direction on the base member 401, and a plurality of second prism-shaped structures 403 which are aligned in a direction perpendicular to the predetermined direction on the first prism-shaped structures 402. In this arrangement, the first prism-shaped structures 402 include first members 410 (first structures, first sub-lenses) which have junction portions (joining portions) 410a to be joined to bottom surfaces 403a of the second prism-shaped structures 403, and second members 411 (second structures, second sub-lenses) which are lower than the first members 410. As described above, the first prism-shaped structures 402 include the first members 410 which are higher than the second members 411. Only the first members 410 have the joining portions 410a to be joined to the second lenses. Therefore, it is possible to decrease the areal size of the joining portion as the entire multilens sheet 400. The light-collecting function, which is to be effected by the first prism-shaped structures 402, is not exerted on the light which passes through the joining portions to travel from the first prism-shaped structures 402 to the second prism-shaped structures 403. Therefore, in order to enhance the effect of the light-collecting function to be brought about by the first prism-shaped structures 402, it is desirable to decrease the areal size of the joining portions. When the joining portions are provided on only the parts of the members (first members) of the first prism-shaped structures 402 as in this modified embodiment, it is possible to decrease the areal size of the joining portions as compared with the case in which the joining portions are provided on all of the first prism-shaped structures 402. It is possible to enhance the light-collecting function to be performed by the first prism-shaped structures.

In the sixth modified embodiment, both of the first members 410 and the second members 411 have the substantially identical shapes. In other words, the second member 411 has the triangular prism shape, and the first member 410 also has the substantially triangular shape having the flat joining portion 410a disposed at the upper portion. However, it is not necessarily indispensable that the first member and the second member have the substantially identical shapes. For example, the first member may have a substantially triangular prism shape, and the second member may have a semicolumnar shape. Further, a height of each of the first members of the first prism-shaped structures is the same with each other, in order to be joined to the second prism structures. However, it is not necessarily indispensable that a shape of each of the first members is the same with each other, and the shape of each of the first member can be formed arbitrary. The number and the arrangement of the first members having the junction portions may be arbitrary in the first prism-shaped structures, provided that the second lenses such as the second prism-shaped structures can be supported and/or fixed stably. Further, it is not necessarily indispensable that a shape of each of the second prism structures is the same with each other, and the shape of each of the second prism structures can be formed arbitrary. Furthermore, it is not necessarily indispensable that the directions of arrangement of the second prism-shaped structures and the first prism-shaped structures are perpendicular to one another. The directions of arrangement may be arbitrary.

The multilens sheets of the first to fourth embodiments and the first to sixth modified embodiments described above are illustrative of the exemplary case wherein the both of the first optical structures for constructing the first optical adjusting layer and the second optical structures for constructing the second optical adjusting layer are arranged periodically (at equal pitches). However, the present invention is not limited thereto. For example, the optical structures may be arranged at random pitches, or the optical structures may be arranged so that a plurality of periods exist in a mixed manner.

The multilens sheets of the first to fourth embodiments and the first to sixth modified embodiments described above are illustrative of the exemplary case wherein all of the plurality of optical structures, which constitute the respective optical adjusting layers, have the same shape and the same size. However, the present invention is not limited thereto. The respective optical adjusting layers may be constructed by combining optical structures having different shapes and different sizes.

The multilens sheets of the first to fourth embodiments and the first to sixth modified embodiments described above are illustrative of the exemplary case of the multilens sheet provided with the two optical adjusting layers. However, the present invention is not limited thereto. Three or more layers of the optical adjusting layers may be provided. Such a multilens sheet can be manufactured by repeating the method for forming the second optical adjusting layer as explained in the production methods of the first to fourth embodiments.

The multilens sheets of the first to third embodiments and the first to sixth modified embodiments described above are illustrative of the exemplary case wherein the base member is formed of the transparent material. However, the present invention is not limited thereto. The base member may be formed of a semitransparent material, i.e., a diffusion sheet. In this arrangement, it is unnecessary to distinctly provide any diffusion sheet in the backlight unit and the liquid crystal display apparatus. Therefore, it is possible to realize thinner sizes of the backlight unit and the liquid crystal display apparatus. In this arrangement, for example, one sheet of the multilens sheet plays the roles of the prism sheet and the diffusion sheet. It is possible to decrease the number of sheets for constructing the backlight unit and-the liquid crystal display apparatus. Therefore, it is possible to further suppress the scattering and the absorption of the transmitted light, and it is possible to further improve the optical performance.

The first to third embodiments described above are illustrative of the exemplary case wherein the multilens member of the present invention is applied to the illumination apparatus and the liquid crystal display apparatus based on the side light system (edge light system) in which the light source is arranged on the side of the optical guide plate. However, the present invention is not limited thereto. The multilens member of the present invention is also applicable of any illumination apparatus and any liquid crystal display apparatus of the direct type in which the light source is provided on the side of the optical guide plate opposite to the liquid crystal display panel. Also in this case, the effect, which is the same as or equivalent to the effect of the first to third embodiments described above, is obtained.

In the multilens member of the present invention, the optical structure, which is formed by joining the first lens group and the second lens group, is formed on the base member. Therefore, it is possible to improve the optical performance, and it is possible to realize the thin size and the low cost for the multilens member, the illumination apparatus, and the liquid crystal display apparatus. Therefore, the multilens member, the illumination apparatus, and the liquid crystal display apparatus of the present invention are preferred for various ways of use.

What is claimed is:

1. A multilens member comprising:
a base member which has light transmissivity;
a plurality of first lenses which are formed on the base member; and
a plurality of second lenses each of which has a first surface facing the base member, and each of which is joined onto one of the first lenses at the first surface, wherein:
the first surface of each of the second lenses has a junction which is joined to one of the first lenses and an overhang which overhangs outwardly from the junction.

2. The multilens member according to claim 1, wherein an angle, which is formed by the overhang of each of the second lenses and the base member, is not less than 180 degrees.

3. The multilens member according to claim 1, wherein each of the second lenses has a tapered shape which is tapered in a direction directed from the base member toward the second lens.

4. The multilens member according to claim 1, wherein the overhang of each of the second lenses is parallel to the base member.

5. The multilens member according to claim 1, wherein hollow spaces are defined by the first lenses and the second lenses.

6. The multilens member according to claim 1, wherein the first lenses include a plurality of first linear members which extend in a first direction, and the first linear members are aligned in a direction perpendicular to the first direction.

7. The multilens member according to claim 6, wherein the second lenses include a plurality of second linear members which extend in a second direction, and the second linear members are aligned in a direction perpendicular to the second direction.

8. The multilens member according to claim 7, wherein the first direction is perpendicular to the second direction.

9. The multilens member according to claim 7, wherein the first direction is parallel to the second direction.

10. The multilens member according to claim 6, wherein a cross section of each of the first lenses in a plane perpendicular to the first direction has a trapezoidal shape.

11. The multilens member according to claim 10, wherein a cross section of each of the second lenses in a plane perpendicular to the second direction has a triangular shape.

12. The multilens member according to claim 1, wherein the plurality of second lenses are arranged such that adjacent second lenses among the plurality of second lenses are separated.

13. The multilens member according to claim 1, wherein each of the first lenses include a first structure which has a joining portion joined to one of the second lenses, and a second structure of which length is shorter than that of the first structure, the length being in a direction from the base member toward the second lenses.

14. The multilens member according to claim 13, wherein a shape of the first structure is substantially same as that of the second structure.

15. An illumination-apparatus comprising:
a light source; and
a multilens member including:
a base member which has light transmissivity;
a plurality of first lenses which are formed on the base member; and
a plurality of second lenses each of which has a first surface facing the base member and each of which is joined onto one of the first lenses at the first surface,
wherein the first surface of each of the second lenses has a junction which is joined to one of the first lenses and an overhang which overhangs outwardly from the junction.

16. The illumination apparatus according to claim 15, further comprising an optical guide plate which guides light emitted from the light source to the multilens member.

17. A liquid crystal display apparatus comprising:
a liquid crystal display device;
a light source; and
a multilens member including:
a base member which has light transmissivity;
a plurality of first lenses which are formed on the base member; and
a plurality of second lenses each of which has a first surface facing the base member and each of which is joined to the plurality of first lenses at the first surface,
wherein the first surface of each of the second lenses has a junction which is joined to one of the first lenses and an overhang which overhangs outwardly from the junction.

18. The liquid crystal display apparatus according to claim 17, further comprising an optical guide plate which guides light emitted from the light source to the multilens member.
